(19) United States
(12) Patent Application Publication
(10) Pub. No.: US 2016/0381443 A1
(43) Pub. Date: Dec. 29, 2016

(54) Routing Methods for Dual Plane Switch Architectures

(71) Applicant: Huawei Technologies Co., Ltd., Shenzhen (CN)

(72) Inventors: Hamid Mehrvar, Kanata (CA); Yi Qian, Shenzhen (CN)

(21) Appl. No.: 14/844,857

(22) Filed: Sep. 3, 2015

Related U.S. Application Data
(63) Continuation of application No. PCT/CN2015/082534, filed on Jun. 26, 2015.

(51) Int. Cl. H04Q 11/00; H04L 12/725; H04B 10/079

(52) U.S. Cl. CPC H04Q 11/0066; H04B 10/07953; H04L 45/302; H04Q 2011/0049

(57) ABSTRACT

A method and apparatus for routing signals through a photonic switch are provided. Optical Signal-to-Noise Ratio (OSNR) requirements for signals to be concurrently routed through the switch are determined, and incoming signal routing requests are blocked when routing same would violate OSNR requirements. Blocking may occur when a maximum allowed number M of lightpaths of same wavelength would be exceeded by admitting the request. Otherwise, signals are routed along a lightpath which satisfies the OSNR requirements. Cell Extinction Ratio in conjunction with OSNR requirements can be used to determine M. Switching cells can potentially accommodate multiple lightpaths of different wavelengths, but regular switching cells may be inhibited from accommodating multiple lightpaths of same wavelength. Routing solutions which maximize both cell sharing and cell packing may be sought. Routes that violate crosstalk limitation conditions are inhibited.

This application is a Continuation of PCT Patent Application No. PCT/CN2015/082534, filed on Jun. 26, 2015, which application is hereby incorporated herein by reference.

### TECHNICAL FIELD

The present invention pertains to photonic switches and in particular to a method and apparatus for routing of signals through a photonic switch.

### BACKGROUND

Silicon photonic integrated circuit (PIC) switches used in applications such as optical networks and datacenters offer compact size, lower power consumption and fabric integration with various optical components on a single substrate. Various switching architectures have been proposed which offer different arrangements of switching cells, such as 1×2, 2×2 and/or 2×1 cells. To improve scalability, it is generally desirable to choose architectures with a relatively lower number of switching cells, however such architectures can suffer from drawbacks such as increased crosstalk, which can be detrimental to the switch performance.

Therefore there is a need for a method and apparatus for crosstalk-managed routing of signals through a crosstalk-prone photonic switching fabric that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for crosstalk-managed routing of signals through a crosstalk-prone photonic switching fabric. In accordance with embodiments of the present disclosure, there is provided a method of handling a request to establish a lightpath in a photonic switch from a specified input to a specified output, the method comprising: determining an Optical Signal-to-Noise Ratio (OSNR) requirement; and when the request can be accommodated while satisfying the OSNR requirement, establishing the lightpath from the specified input to the specified output along a route which satisfies the OSNR requirement.

In various embodiments, the step of determining the OSNR requirement includes determining more than one OSNR requirement. In various embodiments, the OSNR requirement is prescribed for one or more of: optical signal links currently passing through the photonic switch; portions of optical signal links currently passing through the photonic switch; an optical signal link to be established through the photonic switch in association with the request; and a portion of the optical signal link to be established through the photonic switch in association with the request.

In various embodiments, the lightpath corresponds to light of a specified wavelength category, and the method further comprises: determining a maximum number of lightpaths, of the specified wavelength category, that can be concurrently established in the photonic switch, in accordance with an optical crosstalk parameter of the switch and the OSNR requirement; and blocking the request when a violation condition indicating that establishing the lightpath would result in a number of concurrently established lightpaths for the specified wavelength category in excess of the maximum number is met.

In various embodiments, the number of concurrently established lightpaths in the violation condition is equal to a count of optical signal links carrying light of the specified wavelength category which would concurrently pass through the photonic switch.

In various embodiments, establishing the lightpath from the specified input to the specified output comprises: determining a plurality of candidate lightpaths in the photonic switch from the specified input to the specified output; selecting, from among the plurality of candidate lightpaths, a desired lightpath which maximizes a number of shared cells subject to predetermined crosstalk limitation conditions, wherein shared cells are those that concurrently accommodate plural lightpaths; and establishing the lightpath in the photonic switch as the desired lightpath.

In various embodiments, the method further comprises selecting the desired lightpath to maximize a combination of shared cells and cell packing. In various embodiments, selecting the desired lightpath only considers cell packing as it relates to packing of cells in a central column of the photonic switch. In various embodiments, selecting the desired lightpath only considers cell packing as it relates to the packing of crosstalk suppressed cells in the photonic switch.

In various embodiments, the OSNR requirement corresponds to a limit on OSNR penalty to be introduced by the photonic switch into a corresponding optical signal link serviced by the photonic switch. In various embodiments, the limit on OSNR penalty is determined according to a link budget specified for the corresponding optical signal link.

In various embodiments, the method is performed if an Extinction Ratio of the photonic switch is below a threshold, and otherwise an alternative method of handling a request to establish a lightpath in a photonic switch is performed.

In accordance with embodiments of the present disclosure, there is provided a method of handling a request to establish a lightpath in a photonic switch from a specified input to a specified output, the lightpath corresponding to light of a specified wavelength category, the method comprising: determining a maximum number of lightpaths, of the specified wavelength category, that can be concurrently established in the photonic switch, in accordance with an optical crosstalk parameter of the switch and an Optical Signal-to-Noise Ratio (OSNR) requirement; blocking the request when a violation condition indicating that establishing the lightpath would result in a number of concurrently established lightpaths for the specified wavelength category in excess of the maximum number is met; and establishing the lightpath in the photonic switch from the specified input to the specified output in absence of the violation condition.

In various embodiments, the OSNR requirement is prescribed for one or more of: optical signal links currently passing through the photonic switch; portions of optical signal links currently passing through the photonic switch; an optical signal link to be established through the photonic switch in association with the request; and a portion of the optical signal link to be established through the photonic switch in association with the request.

In various embodiments, the number of concurrently established lightpaths for the specified wavelength category corresponds to one greater than a count of optical signal links currently passing through the photonic switch which also correspond to light of the specified wavelength category.

In various embodiments, establishing the lightpath from the specified input to the specified output comprises: determining a plurality of candidate lightpaths in the photonic switch from the specified input to the specified output; selecting, from among the plurality of candidate lightpaths, a desired lightpath which maximizes a number of shared cells subject to a predetermined crosstalk limitation condition, wherein shared cells are those that concurrently accommodate plural lightpaths; and establishing the lightpath in the photonic switch as the desired lightpath.

In various embodiments, optical crosstalk parameters include an Extinction Ratio of the photonic switch.

In accordance with embodiments of the present disclosure, there is provided a method of establishing a lightpath in a photonic switch from a specified input to a specified output, the method comprising: determining a plurality of candidate lightpaths in the photonic switch from the specified input to the specified output; selecting, from among the plurality of candidate lightpaths, a desired lightpath which maximizes a number of shared cells subject to a predetermined crosstalk limitation condition, wherein shared cells are those that concurrently accommodate plural lightpaths; and establishing the desired lightpath in the photonic switch.

In various embodiments, the method further comprises selecting the desired lightpath to maximize a combination of shared cells and cell packing. In various embodiments, cell packing corresponds to a measure of one or both of: a number of contiguously utilized switching cells within one or more columns of the photonic switch; and an average proximity of utilized switching cells within one or more columns of the photonic switch from respective reference cells of said one or more columns. In various embodiments, the desired lightpath is selected to primarily maximize shared cells and to secondarily maximize cell packing.

In various embodiments, the crosstalk limitation conditions include a condition that non-crosstalk-suppressed cells of the photonic switch accommodate at most one lightpath per wavelength category. In various embodiments, the crosstalk limitation conditions include a condition limiting occurrence of one or more orders of same-wavelength crosstalk present in lightpaths accommodated by the photonic switch. In various embodiments, at least one of the crosstalk limitation conditions is adjusted based on optical crosstalk parameters of the photonic switch.

In accordance with embodiments of the present disclosure, there is provided an apparatus for handling a request to route a signal through a photonic switch from a specified input to a specified output, the apparatus comprising a controller having: an OSNR module configured to determine an Optical Signal-to-Noise Ratio (OSNR) requirement; and a routing module operatively coupled to the photonic switch and configured to provide control signals causing the photonic switch to establish a lightpath for routing the requested signal from the specified input to the specified output, the lightpath satisfying the OSNR requirement.

In various embodiments, determining the OSNR requirement includes determining more than one OSNR requirement.

In various embodiments, the routing module is configured to provide control signals when the requested signal is routable through the photonic switch while satisfying the OSNR requirement.

In various embodiments, the OSNR requirement is prescribed for one or more of: optical signal links currently passing through the photonic switch; portions of optical signal links currently passing through the photonic switch; an optical signal link to be established through the photonic switch in association with the request; and a portion of the optical signal link to be established through the photonic switch in association with the request.

In various embodiments, the lightpath corresponds to light of a specified wavelength category, the controller further configured to: determine a maximum number of lightpaths, of the specified wavelength category, that can be concurrently established in the photonic switch, in accordance with an optical crosstalk parameter of the switch and the OSNR requirement; and block the request when a violation condition indicating that establishing the lightpath would result in a number of concurrently established lightpaths for the specified wavelength category in excess of the maximum number is met.

In various embodiments, the number of concurrently established lightpaths for the specified wavelength category is equal to a count of optical signal links carrying light of the specified wavelength category which would concurrently pass through the photonic switch.

In various embodiments, the controller is further configured to: determine a plurality of candidate lightpaths in the photonic switch from the specified input to the specified output; select, from among the plurality of candidate lightpaths, a desired lightpath which maximizes a number of shared cells subject to predetermined crosstalk limitation conditions, wherein shared cells are those that concurrently accommodate plural lightpaths; and establish the lightpath in the photonic switch as the desired lightpath.

In various embodiments, the controller is further configured to select the desired lightpath to maximize a combination of shared cells and cell packing. In various embodiments, the controller is further configured to select the desired lightpath only based on cell packing as it relates to packing of cells in a central column of the photonic switch. In various embodiments, the controller is further configured to select the desired lightpath only based on cell packing as it relates to the packing of crosstalk suppressed cells in the photonic switch.

In accordance with embodiments of the present disclosure, there is provided an apparatus for handling a request to route a signal through a photonic switch from a specified input to a specified output, the signal to be routed along a lightpath and corresponding to light of a specified wavelength category, the apparatus comprising a controller configured to: determining a maximum number of lightpaths, of the specified wavelength category, that can be concurrently established in the photonic switch, in accordance with an optical crosstalk parameter of the switch and an Optical Signal-to-Noise Ratio (OSNR) requirement; and block the request when a violation condition indicating that establishing the lightpath would result in a number of concurrently established lightpaths for the specified wavelength category in excess of the maximum number is met; and the controller further comprising a routing module operatively coupled to the photonic switch and configured to provide control signals causing the photonic switch to establish the lightpath from the specified input to the specified output in absence of the violation condition.

In various embodiments, the OSNR requirement is prescribed for one or more of: optical signal links currently passing through the photonic switch; portions of optical signal links currently passing through the photonic switch; an optical signal link to be established through the photonic switch in association with the request; and a portion of the optical signal link to be established through the photonic switch in association with the request.

In various embodiments, the number of concurrently established lightpaths for the specified wavelength category corresponds to one greater than a count of said optical signal links or said portions of optical signal links currently passing through the photonic switch which also correspond to light of the specified wavelength category.

In accordance with embodiments of the present disclosure, there is provided an apparatus for routing a signal through a photonic switch from a specified input to a specified output, the signal to be routed along a lightpath, the apparatus comprising a controller configured to: determine a plurality of candidate lightpaths in the photonic switch from the specified input to the specified output; and select, from among the plurality of candidate lightpaths, a desired lightpath which maximizes a number of shared cells subject to predetermined crosstalk limitation conditions, wherein shared cells are those that concurrently accommodate plural lightpaths, the controller further comprising a routing module operatively coupled to the photonic switch and configured to provide control signals causing the photonic switch to establish the desired lightpath in the photonic switch.

In various embodiments, the controller is further configured to select the desired lightpath to maximize a combination of shared cells and cell packing.

In various embodiments, cell packing corresponds to a measure of one or both of: a number of contiguously utilized switching cells within one or more columns of the photonic switch; and an average proximity of utilized switching cells within one or more columns of the photonic switch from respective reference cells of said one or more columns.

### BRIEF DESCRIPTION OF THE DRAWINGS

Further features and advantages of the present invention will become apparent from the following detailed description, taken in combination with the appended drawings, in which:

FIG. 1 illustrates a method for routing signals through a photonic switch based on OSNR requirements, in accordance with embodiments of the present invention.

FIG. 2 illustrates another method for handling a request to establish a lightpath through a photonic switch based on OSNR requirements, in accordance with embodiments of the present invention.

FIG. 3 illustrates another method for establishing a lightpath through a photonic switch based on OSNR requirements, in accordance with embodiments of the present invention.

FIG. 4 illustrates an apparatus for handling a request to establish a lightpath in a photonic switch and/or for establishing the lightpath, in accordance with embodiments of the present invention.

FIG. 5 illustrates signal leakage in a switching cell, in accordance with some embodiments of the present invention.

FIG. 6 illustrates an example of crosstalk arising in a photonic switching fabric, in accordance with some embodiments of the present invention.

FIG. 7 illustrates an example 8×8 Hybrid Dilated Benes photonic switch architecture, which may be controlled in accordance with embodiments of the present invention.

FIG. 8 graphically illustrates determination of a maximum number of lightpaths through a photonic switch based on a maximum value of OSNR penalty for the switch and an Extinction Ratio for the switch, in accordance with embodiments of the present invention.

FIGS. 9a to 9f illustrate an example of establishing lightpaths in accordance with an embodiment of the present invention.

FIGS. 10a to 10g illustrate another example of establishing lightpaths in accordance with an embodiment of the present invention.

FIGS. 11a to 11b illustrate another example of establishing lightpaths in accordance with an embodiment of the present invention.

FIG. 12 illustrates an example of a crosstalk-suppressed switching cell formed from a cross-coupled arrangement of four regular switching cells, which may be present in switching fabrics controlled in accordance with embodiments of the present invention

FIG. 13 illustrates crosstalk limitation conditions pertaining to potential switching cell configurations, in accordance with embodiments of the present invention.

FIG. 14 illustrates adaptive routing provided in accordance with an embodiment of the present invention.

FIG. 15 illustrates an optical network node having multiple ports, provided in accordance with an embodiment of the present invention.

FIG. 16 illustrates a high-performance computing architecture provided in accordance with an embodiment of the present invention.

It will be noted that throughout the appended drawings, like features are identified by like reference numerals.

### DETAILED DESCRIPTION OF ILLUSTRATIVE EMBODIMENTS

As used herein, the term “about” should be read as including variation from the nominal value, for example, a +/−10% variation from the nominal value. It is to be understood that such a variation is always included in a given value provided herein, whether or not it is specifically referred to.

Embodiments of the present invention relate to routing of signals over lightpaths through a photonic switch based on Optical Signal-to-Noise Ratio (OSNR) requirements. Requests for establishing of lightpaths from a specified input to a specified output of the photonic switch may be received, for example asynchronously. For clarity, requests may nominally be requests to route optical signals through the photonic switch, and it is considered herein that such optical signals are routed by selecting and then establishing lightpaths in the switch, which the optical signals then follow. As such, for ease of disclosure, requests for routing optical signals may be referred to herein as requests for establishing lightpaths.

The OSNR requirements may relate to limits on acceptable amounts of optical noise introduced by the photonic switch, and/or other optical components, into optical signal link portions corresponding to the newly requested lightpaths and/or currently established lightpaths. OSNR requirements may be different for different lightpaths. For a given lightpath, the OSNR requirement can correspond to a limit on OSNR penalty to be introduced by the photonic switch into that lightpath. The limit on OSNR penalty in turn may be dictated by a link budget specified for an optical signal link of which the given lightpath forms a part. The limit on OSNR penalty may be provided by a higher-level optical network control function, for example. As will be readily understood by a worker skilled in the art, OSNR penalty is derived based on a reference bit error rate.

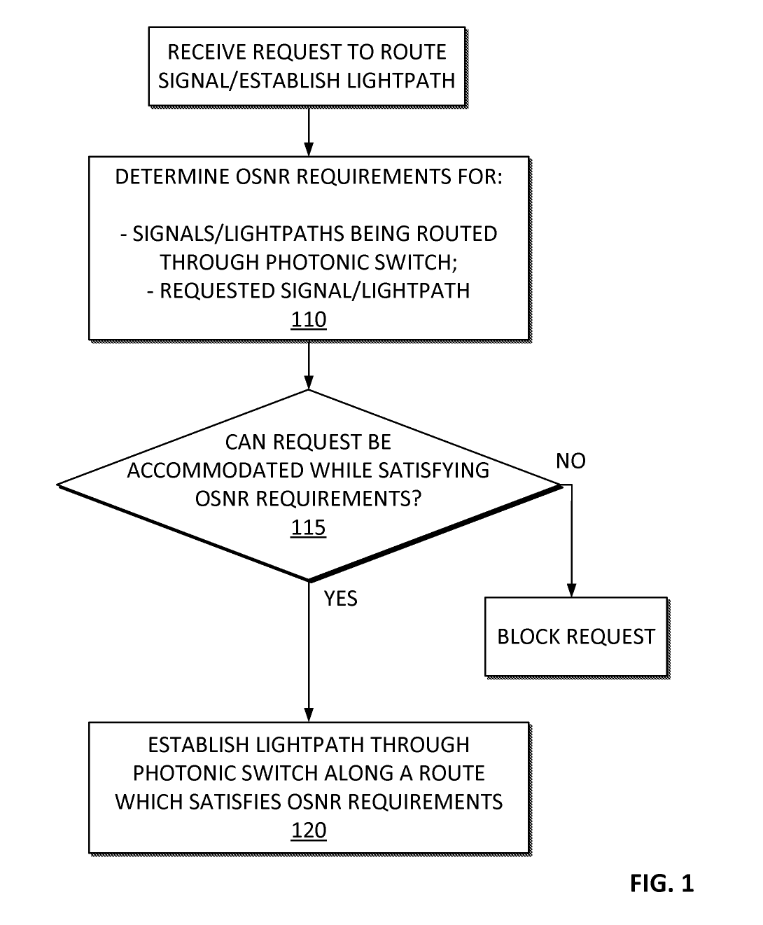

Having reference to FIG. 1, handling a request to establish a lightpath through a photonic switch from a specified input to a specified output may include determining 110 one or more Optical Signal-to-Noise Ratio (OSNR) requirements for respective signals carried over the lightpaths. Such signals may include signals being routed through the photonic switch, the requested signal, or both. More particularly, the OSNR requirements may be for portions of optical signal links passing through and/or requested to pass through the photonic switch. For example, where an overall OSNR requirement is an end-to-end metric for an optical signal link, a portion of this metric may be allocated to a corresponding portion of the optical signal path which passes through the photonic switch or switching node housing the photonic switch. When the optical link is divided into multiple portions or sections each having its own OSNR requirement, the overall (end-to-end) OSNR requirement can be respected by respecting the OSNR requirements for each of these portions or sections. The overall OSNR requirement may be expressed as the sum of the OSNR requirements for the portions/sections.

Establishing the lightpath may further include implicitly or explicitly determining 115 whether the request can be accommodated while satisfying the OSNR requirements. Routing the signal may further include, when the request can be accommodated (while satisfying the OSNR requirements), establishing 120 the lightpath from the specified input to the specified output along a route which satisfies the OSNR requirements. In some embodiments this may be alternatively described as routing the requested signal through the photonic switch from the specified input to the specified output along a lightpath which satisfies the one or more OSNR requirements. The OSNR requirements may correspond to statically or dynamically specified OSNR penalty values which are to be respected. OSNR penalty may be limited for example to achieve a desired link budget for a given signal path through multiple network nodes, including a network node comprising the photonic switch.

A first example of routing based on OSNR requirements is OSNR-aware request admission control, in which a request to route a signal over a lightpath is accepted only if the signal can be routed, and the corresponding lightpath can be established, while respecting the OSNR requirements for that lightpath as well as maintaining the OSNR requirements for other lightpaths that are already carrying signals through the switch. As such, if routing the requested signal over a lightpath cannot be performed while satisfying the OSNR requirements of the requested lightpath and/or routing the requested signal over a lightpath would cause OSNR requirements of other lightpaths to no longer be met, the request is not accepted. A second example of routing based on OSNR requirements is, following accepting a request to route a signal over a lightpath, determining a lightpath through the photonic switch which satisfies the OSNR requirements. This may be referred to as OSNR-aware routing.

In some embodiments, admission control is performed by blocking, e.g. refraining from routing, requests to route signals where accommodating such requests would result in more than a predetermined maximum number of “same wavelength category” connections being concurrently routed by the switch. The predetermined maximum number may be based on predetermined OSNR requirements, as well as properties of the switch such as cell Extinction Ratios (ER).

In some embodiments, routing a signal over a lightpath based on OSNR requirements comprises selecting a lightpath subject to given crosstalk limitation conditions. The crosstalk limitation conditions are imposed to restrict the selected lightpath from exhibiting certain patterns that would result in unacceptable amounts of crosstalk which tend to degrade OSNR either of the lightpath being established, existing lightpaths, or both. For example, one crosstalk limitation condition dictates that all regular switching cells of the photonic switch accommodate at most one lightpath in each of a plurality of wavelength categories. Crosstalk-suppressed switching cells may be allowed to accommodate more than one lightpath of a given wavelength category.

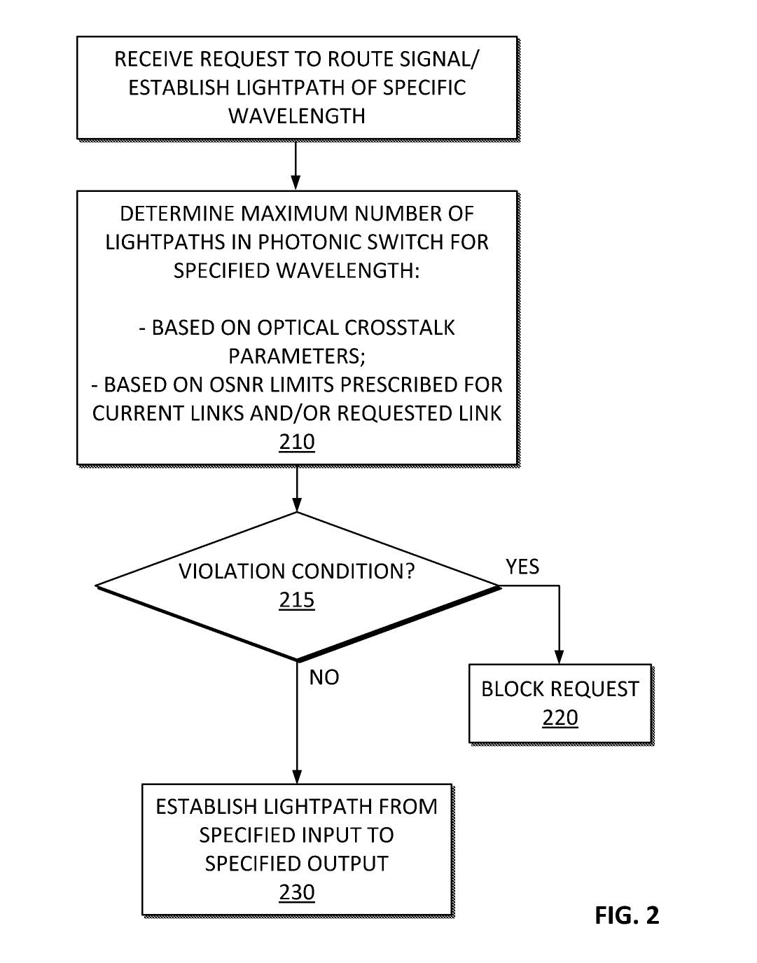

Embodiments of the present invention are directed toward a method of handling a request to establish a lightpath in a photonic switch from a specified input to a specified output. The lightpath corresponds to light of a specified wavelength category, which may be specified in the request. Having reference to FIG. 2, the method includes determining 210 a maximum number of lightpaths in the specified wavelength category to be concurrently established in the photonic switch. The determination is based on optical crosstalk parameters of the switch and on Optical Signal-to-Noise Ratio (OSNR) limits prescribed for one or both of: portions of optical signal links currently passing through the photonic switch; and a portion of an optical signal link to be established through the photonic switch in association with the request. An OSNR limit may be an upper limit on OSNR penalty introduced by the photonic switch. The method further includes explicitly or implicitly determining 215 whether a violation condition is met. The violation condition indicates that satisfying the request would result in a number of concurrently established lightpaths for the specified wavelength category exceeding the maximum number. The method continues to the step of establishing 230 the lightpath in the photonic switch from the specified input to the specified output in absence of the violation condition. In some embodiments, when a violation condition is met, the method includes blocking 220 the request.

Requests to establish lightpaths may be received, and lightpaths assigned, asynchronously. As such, it may not be possible to re-arrange existing lightpaths to accommodate new requests. If a request cannot be accommodated by the switch, it can be blocked. Notably, a request may be blocked when the violation condition is met, even if a potential lightpath through the switch exists from a specified input to a specified output. As such, the admission control at the photonic switch is OSNR-aware. Blocked requests may be handled in a number of different ways. In some embodiments, blocked requests can be examined at the optical network level as part of a Routing and Wavelength Assignment (RWA) process to route the blocked signal through a different photonic switch node, to drop the lightpath in the same node or another node, or to convert the wavelength of the lightpath to another wavelength that meet the OSNR requirement. Other ways of handling the blocking of a request will be apparent to those skilled in the art.

Embodiments of the present invention include consideration that optical signals in multiple wavelength categories can potentially be accommodated by the same photonic switch. A wavelength category relates to the optical frequency band which nominally carries the optical signal, for example centered at a given optical carrier wavelength. Typically, a wavelength-multiplexed optical communication system includes a discrete number of different wavelength categories, which are designed to be non-overlapping. Crosstalk between different wavelength categories may be less of a concern. Crosstalk between optical signals in the same wavelength category is a primary concern. As such, the number of signals being accommodated by a photonic switch in each wavelength category is limited. One skilled in the art will appreciate that the number of signals in a given wavelength category that can be accommodated may be a function of the characteristics of the switching cells, and the overall ability of the switch to suppress crosstalk.

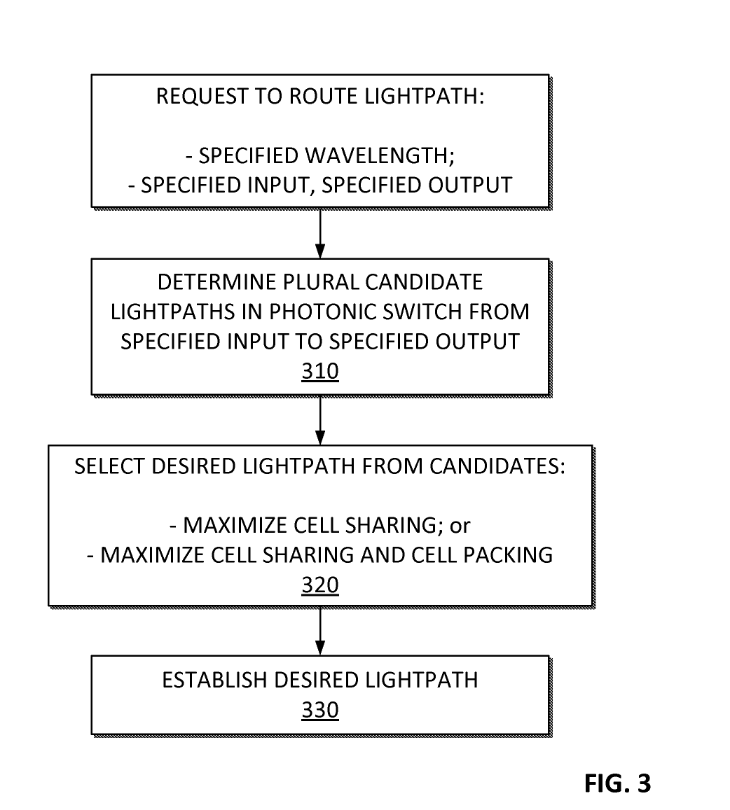

Embodiments of the present invention are directed toward a method of establishing a lightpath in a photonic switch from a specified input to a specified output. This method may be performed separately or in conjunction with the method of handling a request to establish a lightpath. For example, this method may be performed as part of operation 230 of FIG. 2. Having reference to FIG. 3, the method includes determining 310 a plurality of candidate lightpaths in the photonic switch from the specified input to the specified output. The method further includes selecting 320, from among the plurality of candidate paths, a desired lightpath which maximizes cell sharing, or which maximizes a combination of cell sharing and cell packing. Cell sharing corresponds to a number of switching cells of the photonic switch that concurrently accommodate plural lightpaths subject to predetermined crosstalk limitation conditions. Cell packing can correspond to a measure of one or both of: a number of contiguously utilized switching cells within one or more columns of the photonic switch; and an average proximity of utilized switching cells within one or more columns of the photonic switch from respective reference cells of said one or more columns. The method further includes establishing 330 the desired lightpath in the photonic switch. Those skilled in the art will appreciate that in certain circumstances, in performing step 310, a single candidate lightpath will be identified. In this case, in place of selecting a desired lightpath from the plurality, the single candidate lightpath will be selected so long as it does not result in a violation condition.

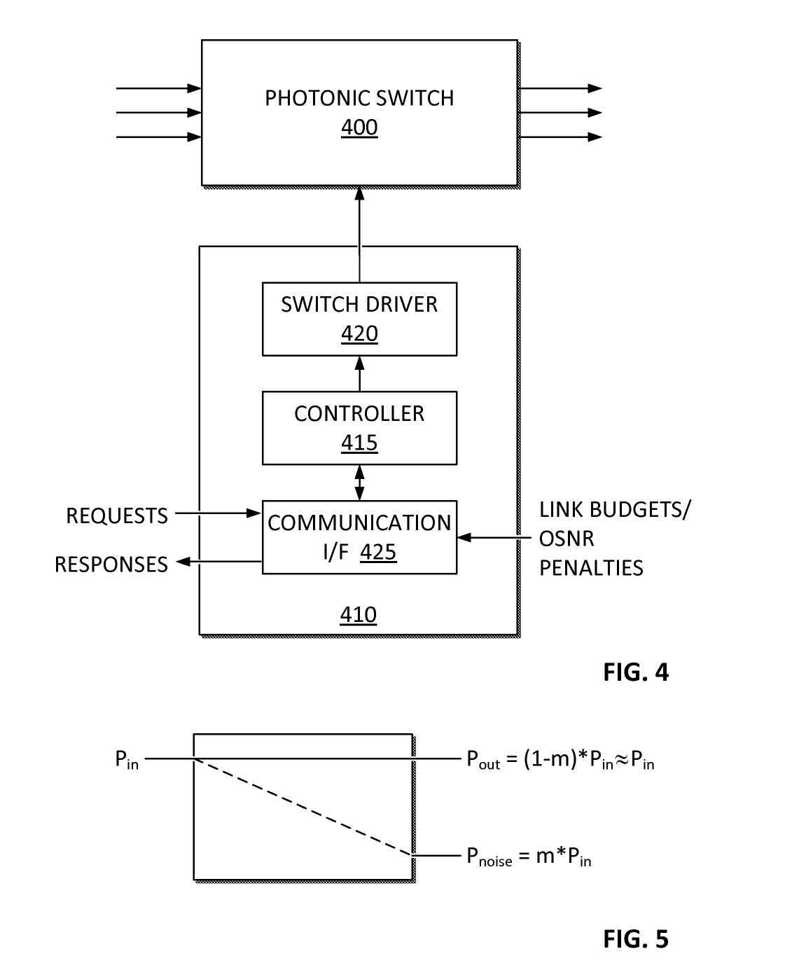

Embodiments of the present invention are directed toward an apparatus for OSNR-aware routing signals by the selection and/or establishment of lightpaths through a crosstalk-prone photonic switching fabric. FIG. 4 illustrates an apparatus 410 for handling a request to establish a lightpath in a photonic switch 400 and/or for establishing the lightpath, in accordance with some embodiments of the present invention. The apparatus 410 includes a controller 415 which may be functionally subdivided into various modules for performing various respective control tasks as described herein, such as admission control tasks related to determining whether a request to establish a lightpath is blocked or admitted, and routing tasks related to determining a lightpath for routing an optical signal through the switch. The controller may include an appropriately configured microcontroller, microprocessor operatively coupled to memory, or the like. The apparatus includes a communication interface 425 which is communicatively coupled to the controller 415 as well as to other devices in the optical network and configured to receive requests for establishing lightpaths through the photonic switch, along with information such as link budget information and/or OSNR penalty information for use by the controller in establishing lightpaths in an OSNR-aware manner. The communication interface may be configured to respond to requests to establish lightpaths, for example to indicate that the request is blocked for a given photonic switch. The apparatus includes a switch driver 420 which is communicatively coupled to the controller 415 as well as to the photonic switch 400 itself. The switch driver 420 is configured to provide control signals, such as binary control signals causing specified switching cells of the photonic switch to operate in the bar or cross configuration, in order to establish lightpaths as specified by the controller. In some embodiments, a single controller may control plural photonic switches, for example provided in a bank of parallel switches. Each photonic switch includes multiple inputs for receiving optical signals and multiple outputs for providing optical signals. The multiple inputs are connected in controllable combinations to the optical outputs by operation of the switch, as directed by the controller.

In various embodiments, crosstalk-managed routing comprises OSNR-aware routing for photonic switches, such as switches utilizing 2×2 switching cells. The OSNR-aware routing may determine when and where to share 2×2 switching cells among two lightpaths, based on wavelength categories of the lightpaths, the Extinction Ratio of the cells, and a specified acceptable level of OSNR penalty. The OSNR-aware routing may additionally or alternatively attempt to reduce switch blocking probability by maximizing the number of switching cells that are shared among two lightpaths. The OSNR-aware routing may additionally or alternatively determine, based on specified acceptable levels of OSNR penalty, maximum numbers of same-wavelength-category connections that can be accommodated in the same switching fabric. Cell sharing and OSNR penalty may generally oppose one another, and embodiments of the present invention seek to balance or trade off these two objectives for a given level of Extinction Ratio, by sharing cells to a limited extent, such that specified acceptable levels of OSNR penalty are still maintained. As such, embodiments of the present invention perform admission control and/or lightpath selection for signal routing based on two dimensions of consideration, namely path blocking probability and OSNR penalty. One or more of connection wavelength categories, cell Extinction Ratio, cell sharing, and OSNR penalty limits may be considered in performing admission control and/or lightpath selection and/or lightpath establishment in support of signal routing.

In some embodiments, requests for establishing a lightpath in a photonic switch may be explicit requests made in accordance with a given communication protocol. In other embodiments, requests for establishing a lightpath in a photonic switch may be implicit requests. For example, activity in an optical network may be monitored and certain activities corresponding to setting up an optical link through the switch may be interpreted as requests for establishing a lightpath through the switch.

Some embodiments of the present invention additionally or alternatively provide for a method and apparatus for routing a signal through a photonic switch from a specified input to a specified output. One or more OSNR requirements for signals are determined including: the requested signal and one or more signals being routed through the photonic switch. When the requested signal is routable through the photonic switch while satisfying the one or more OSNR requirements, the requested signal is routed through the photonic switch from the specified input to the specified output along a lightpath which satisfies the one or more OSNR requirements.

Embodiments of the present invention relate to the operation of photonic switches. The present invention may be applicable to various photonic switching architectures which exhibit the potential for crosstalk due for example to the presence of switching cells that are coupled to plural upstream switching cells, both of which are potentially utilized. Example switching architectures include, but are not limited to, the Benes architecture, dual plane architectures such as a Dilated Benes architecture, a Hybrid Dilated Benes architecture, multi-stage CLOS, or other single-plane, dual-plane or multi-plane architectures.

Embodiments of the present invention relate to the operation of photonic switches, such as silicon-based photonic integrated circuit switches, comprising interconnected switching cells, such as typical 2×2 switching cells. Such switching cells may be, for example, 2×2 Mach-Zehnder interferometer cells, 1×N/N×1 multi-mode interferometer cells, 2×2 micro-ring resonators, or the like. 2×2 switching cells having a first and second input and a first and second output may be operable in either a “bar” or pass-through configuration or in a “cross” configuration. A control signal to the switching cell may dictate which configuration is present. In the bar configuration, a signal at the first input is passed to the first output and a signal at the second input is passed to the second output, while in the cross configuration, a signal at the first input is passed to the second output and a signal at the second input is passed to the first output. Basic operation of photonic switches of this type would be readily understood by a worker skilled in the art, for example as set forth in U.S. Patent Application Publication No. 2015/0055951.

However, switching cells such as those of the type described above can suffer from signal leakage. While the majority of a signal at one of the cell inputs is routed to the intended output, a certain amount of input signal power may leak to the non-intended output. Thus, for example even when a switching cell is operated in the “bar” configuration, a nominal percentage of the signal presented at the first input may appear at the second output.

The amount of signal leakage in a cell can be described in terms of the Extinction Ratio (ER) of a cell. FIG. 5 illustrates a switching cell operating in the “bar” configuration, so that, for an input signal having power level Pᵢₙ, a proportion (1−m) of the input power is available at the first, intended output across from the input, while a proportion (m) of the input power is leaked to the second, unintended output. The value of m is typically substantially less than 0.5, for example m may be equal to 0.01. The output signal power is therefore Pₒᵤₜ=(1−m)Pᵢₙ, while the noise power is Pₙₒᵢₛₑ=(m)Pᵢₙ.

In various photonic switches, a single switching cell can accommodate multiple signals. For example a 2×2 switching cell simultaneously routes signals presented at both its inputs. When two lightpaths are established through a regular switching cell, first-order crosstalk can occur. More specifically, first-order crosstalk results from the signal leakage of a first lightpath provided at one input of a cell directly coupling onto an output used for passing a second lightpath through the same cell.

Referring again to FIG. 5, the amount of crosstalk can be measured in dB as 10 log₁₀(m), which substantially equals the ratio of noise power to input power as measured in dB. For example, when m equals 0.01, the amount of crosstalk is −20 dB. It is noted that the Extinction Ratio can be approximately measured, in dB, as the ratio of input power to noise power, that is 10 log₁₀(1/m). As such, Extinction Ratio and crosstalk power as measured in dB can be considered, to at least a first approximation, to be negatives of one another. That is, if the nominal Extinction Ratio for cells in a switching fabric is X dB, then the first order crosstalk is expected to be measured at about −X dB.

It is recognized herein that first-order crosstalk between two lightpaths of the same wavelength category may be unacceptable when the Extinction Ratio is sufficiently low, for example below a threshold such as 28 dB or 30 dB. As such, embodiments of the present invention avoid occurrences of such first-order crosstalk at least for given ranges of Extinction Ratio.

Higher-order crosstalk can also occur in a switching fabric. For example, when only a first lightpath passes through a first switching cell, signal leakage causes a minor portion of the first lightpath to pass to the non-intended output of that cell (e.g. the “cross” output when the cell is in “bar” configuration or vice-versa.) When this non-intended output is directly coupled to the input of a second cell, signal leakage can again occur in the second cell. If this second cell is also used to pass a second lightpath, the twice-leaked signal from the first lightpath coupled onto the second lightpath results in second-order crosstalk.

Continuing in the above manner, it can be seen that third-order crosstalk can result from signal leakage in three consecutive cells, fourth-order crosstalk can result from signal leakage in four consecutive cells, and so on. In general, when the Extinction Ratio of cells in a switching fabric is X, n^{th} order crosstalk has a strength of −nX dB. It is considered that crosstalk can be coupled onto a lightpath at multiple cells within the switch, and hence may be cumulative.

It is further noted herein that, when signal leakage propagates along a path in the switching fabric, not only does further signal leakage occur at every cell encountered to give rise to progressively higher orders of crosstalk, but, if the signal leakage reaches a switching cell which is set in an explicit “cross” or “bar” configuration, a major proportion (1−m) of the signal leakage can be propagated through the switching cell to one output, while a minor proportion (m) can be propagated to the other. For simplicity, when signal leakage corresponding to n^{th} order crosstalk is propagated through a switching cell in this manner, the switching cell output may still be referred to as n^{th} order crosstalk, even though it is slightly degraded. Thus, when signal leakage corresponding to n^{th} order crosstalk is applied to one input of a switching cell, that switching cell may provide at one output signal leakage corresponding to n^{th} order crosstalk, and at the other output signal leakage corresponding to (n+1)^{st} order crosstalk. Alternatively, a more rigorous model which considers lightpaths subject to dispersion in discrete increments corresponding to encounters with subsequent switching cells may be developed. In one such model, fractional orders of crosstalk may be present.

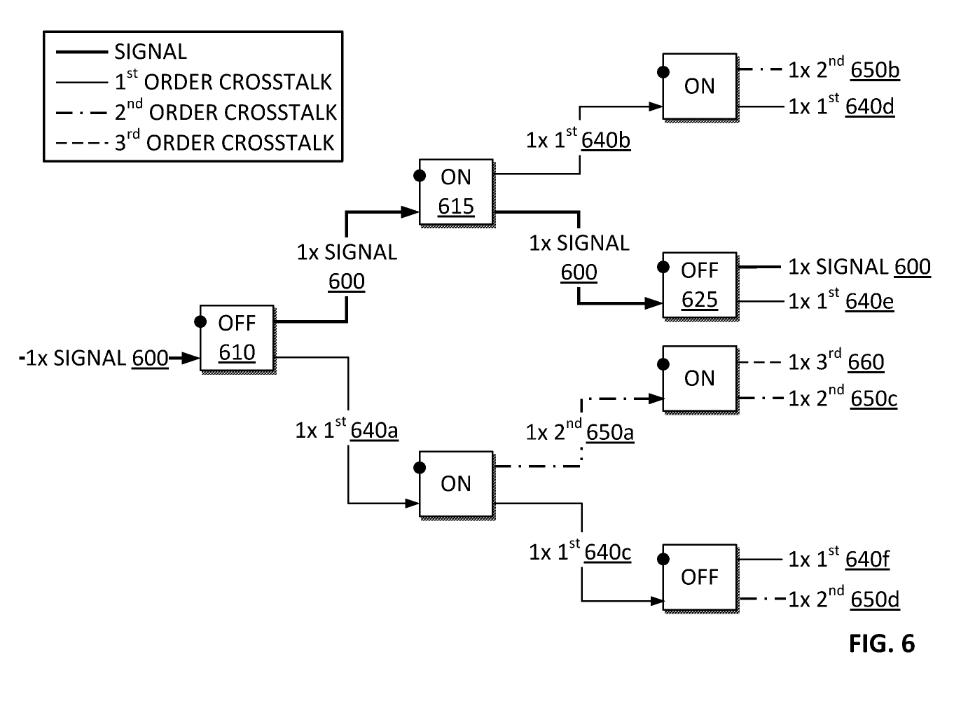

FIG. 6 illustrates an example of a situation potentially giving rise to various orders of crosstalk. A set of interconnected 2×2 switching cells is shown, which may form part of a switching fabric. Each cell has an upper input, a lower input, an upper output and a lower output. When a cell is in the “ON” configuration, it operates in the “bar” state, such that: a major proportion (1−m) of a signal at the upper input is routed to the upper output, a leakage proportion (m) of the signal at the upper input is routed to the lower output, a major proportion (1−m) of a signal at the lower input is routed to the lower output, and a leakage proportion (m) of the signal at the lower input is routed to the upper output. When a cell is in the “OFF” configuration, it operates in the “cross” state, such that: a major proportion (1−m) of a signal at the upper input is routed to the lower output, a leakage proportion (m) of the signal at the upper input is routed to the upper output, a major proportion (1−m) of a signal at the lower input is routed to the upper output, and a leakage proportion (m) of the signal at the lower input is routed to the lower output. The value of m is typically small, for example about 0.01. A single input signal 600 is provided to cell 610 and nominally routed through cells 615 and 625. According to the above-described model, this results in potential first-order crosstalk at multiple locations 640a, 640b, 640c, 640d, 640e, 640f. That is, if another lightpath is established through these locations, first-order crosstalk is considered to occur. Potential second-order crosstalk similarly occurs at multiple locations 650a, 650b, 650c, 650d. Potential third-order crosstalk similarly occurs at location 660.

Although signal leakage as described above can occur regardless of wavelength category, crosstalk as used herein is primarily concerned with crosstalk between lightpaths belonging to the same wavelength category, also referred to as same-wavelength crosstalk, also referred to as in-band crosstalk. As such, in various embodiments, crosstalk which occurs between two signals belonging to different wavelength categories is ignored, and may even be deemed not to occur at all in the description herein.

Since first-order crosstalk can impact OSNR, embodiments of the present invention establish lightpaths in a manner that avoids or mitigates first-order crosstalk. Since higher-order crosstalk can also impact OSNR, embodiments of the present invention limit the number of lightpaths of same wavelength category that are concurrently handled by the photonic switch. Additionally or alternatively, some embodiments may establish lightpaths in a manner that mitigates instances of higher-order crosstalk.

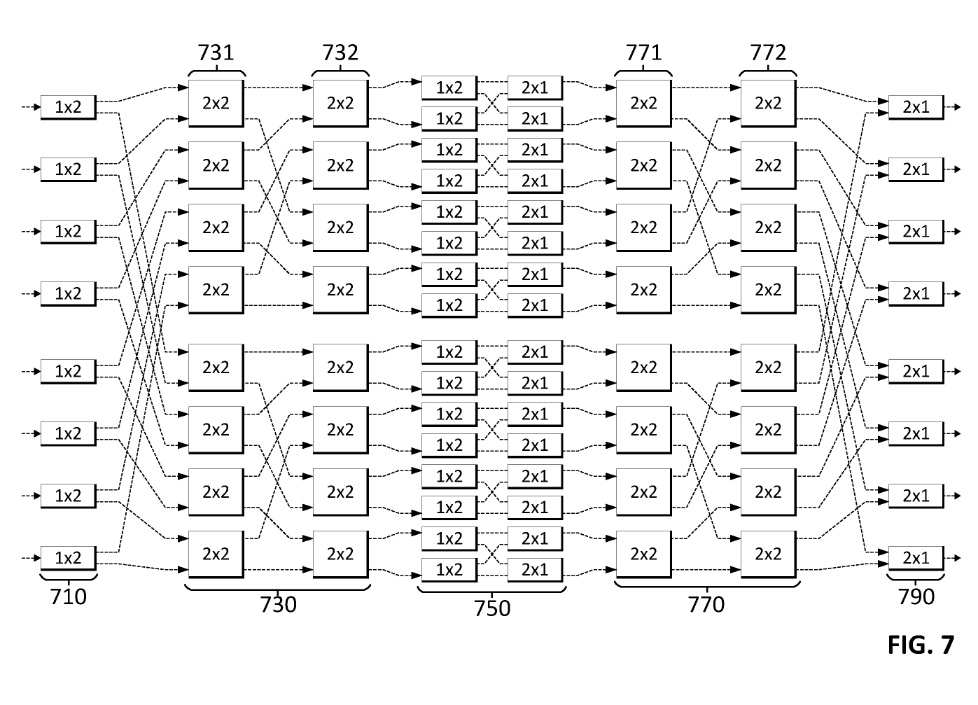

FIG. 7 illustrates an 8×8 Hybrid Dilated Benes photonic switch architecture, which may be controlled in accordance with embodiments of the present invention. Other switch architectures may also be controlled. The switch includes an ingress column 710 of 1×2 cells, an egress column 790 of 2×1 cells, a first intermediate switching stage 730 corresponding to a Benes arrangement of 2×2 cells, a second intermediate switching stage 770 corresponding to another Benes arrangement of 2×2 cells, and a central column of crosstalk-suppressed cells 750 each corresponding to a 2×2 dilated Banyan architecture are used in the central column. Each of the intermediate switching stage 730, 770 includes two columns 731-732, 771-772 of two-by-two switching elements.

Various practical applications call for photonic switches of relatively large size, such as switches having 16, 32 or 64 inputs and outputs, or switches having even higher numbers of inputs and outputs. For example, the Hybrid Dilated Benes architecture of FIG. 7 may be scaled to an N×N version, where N is a power of 2. In this case, the number of switching cells is about 2N(log₂N+2). Those skilled in the art will appreciate that N being a power of 2 is not intended as a restriction of the scope of the invention, but is instead a limitation of certain embodiments for ease of implementation.

Embodiments of the present invention relate to OSNR-aware admission control, in which a request to route a signal is accepted only if the signal can be routed while respecting the OSNR requirements for that signal as well as the OSNR requirements for other signals already being routed. This is in view of the possibility that a newly routed signal can potentially degrade OSNR of existing signals. The possibility of respecting OSNR requirements can be considered based on optical crosstalk parameters of the switch, for example as given in the form of an Extinction Ratio for the switch.

In various embodiments, requests to route signals through a switch are received asynchronously, for example one at a time. As such, the switch may already be routing signals via various established lightpaths, and it may be desired to avoid interrupting these already established lightpaths or degrading their OSNR. In some embodiments, OSNR requirements for all lightpaths are respected. In other embodiments, some routing may be performed without respect to the OSNR requirements of some lower-priority signals/lightpaths. In such cases, the OSNR penalty for such lower-priority cases can be effectively set to infinity. As noted above, OSNR requirements may be different for different lightpaths and may correspond to a limit on OSNR penalty to be introduced by the photonic switch into a given lightpath.

In some embodiments, a request for establishing a lightpath for routing a signal is considered by determining whether there exists a lightpath through the photonic switch that satisfies the request and that also respects the various OSNR requirements. If such a path exists, the lightpath is established according to one of these feasible routes.

In some embodiments, a maximum number of lightpaths in each of a plurality of wavelength categories is determined and used for admission control. The maximum number of lightpaths specifies the maximum allowed number of lightpaths per wavelength category that can be concurrently established through the switch while guaranteeing that the OSNR requirements are respected. In some embodiments, this maximum number M is the same for each wavelength category, such that the switch can establish up to M lightpaths in each different wavelength category. The maximum number M can potentially differ between wavelength categories.

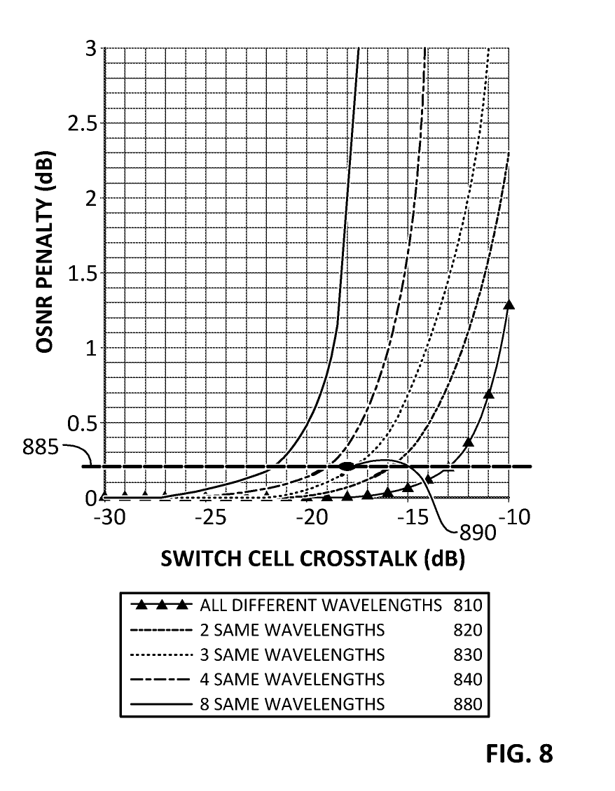

In various embodiments, the maximum number of lightpaths is determined based on optical crosstalk parameters of the switch in combination with the prescribed OSNR limits. In one embodiment, if multiple OSNR limits are prescribed for the switch, for example corresponding to multiple lightpaths, the strictest OSNR limit may be used, for example the lowest value of OSNR penalty upper limit. The optical crosstalk parameters of the switch can be specified as a nominal Extinction Ratio for the switch. In various embodiments, an optical crosstalk parameter of the switch may refer to a corresponding optical crosstalk parameter of switching cells within the switch, for example as discussed with respect to FIG. 8. In some embodiments the nominal Extinction Ratio for a switch may refer to the nominal Extinction Ratio for switching cells within the switch. In some embodiments, this optical crosstalk parameter is assumed to be substantially equal for each switching cell of a switch. In some embodiments, if optical crosstalk parameters vary significantly between switching cells of the same switch, an average or worst-case analysis may be used.

FIG. 8 graphically illustrates determination of a maximum number of lightpaths through a photonic switch based on a maximum value of OSNR penalty for the switch and an Extinction Ratio for the switch. The graph shows OSNR penalty versus switch cell crosstalk, both measured in dB, for various cases corresponding to the number of lightpaths of the same wavelength category being established through the switch. The switch cell crosstalk corresponds to the optical crosstalk parameters of the switch. For example the crosstalk measurement for a given switch can be deemed equal to the negative of its nominal Extinction Ratio. The illustrated graph is for an 8×8 Hybrid Dilated Benes switch, although similar graphs can be derived for other switches.

In particular, curve 810 corresponds to the case where one lightpath per wavelength category is established through the switch. Curve 820 corresponds to the case where at least one wavelength category includes two lightpaths established through the switch but no wavelength category includes more than two lightpaths established through the switch. Curve 830 corresponds to the case where at least one wavelength category includes three lightpaths established through the switch but no wavelength category includes more than three lightpaths established through the switch. Curve 840 corresponds to the case where at least one wavelength category includes four lightpaths established through the switch but no wavelength category includes more than four lightpaths established through the switch. Curve 880 corresponds to the case where at least one wavelength category includes eight lightpaths established through the switch but no wavelength category includes more than eight lightpaths established through the switch.

As can be seen from FIG. 8, as the number of lightpaths in a wavelength category increases, OSNR penalty increases faster as a function of switch cell crosstalk. To determine the maximum number of lightpaths per wavelength category allowed concurrently in the switch, a maximum value of OSNR penalty and a nominal Extinction Ratio for the switch are determined. The maximum number of lightpaths can be determined as the maximum number of lightpaths specified in the cases corresponding to curves which pass underneath the point in the graph which corresponds to the maximum value of OSNR penalty and the negative of the nominal Extinction Ratio. As an example, a maximum OSNR penalty 885 of 0.2 dB is shown. If, for example, the nominal Extinction Ratio for the switch is 18 dB, then the switch cell crosstalk can be taken as −18 dB and the point 890 on the graph is identified. In this case, the maximum number of allowed lightpaths per wavelength category is three, since the curve 830 passes underneath the point 890. If the Extinction Ratio or the maximum value of OSNR penalty were higher, more lightpaths per category might be allowed. At an Extinction Ratio of about 28 dB or 30 dB, all lightpaths can be of the same wavelength, even for very small maximum values of OSNR penalty.

As such, if accommodating a current request to establish a lightpath in the photonic switch would result in a number of concurrently established lightpaths for one of the plurality of wavelength categories exceeding the maximum number, then a violation condition is declared and the request is blocked. Otherwise, in absence of the violation condition, the request is accepted and an attempt is made to establish the lightpath by searching for a feasible route through the switch from an input to an output both of which are specified in the request.

In various embodiments, determining the maximum number of lightpaths as above may be based on the understanding that certain crosstalk limitation conditions will be imposed on the lightpaths. For example, the curves illustrated in FIG. 8 may be derived based on the assumption that lightpaths of the same wavelength category will not be established through the same switching cells.

Embodiments of the present invention may execute admission control as described above by use of a lookup table or other functional relationship which provides admission control decisions based on current input and/or state parameters. Input and/or state parameters may include OSNR requirements for links currently serviced by the photonic switch, OSNR requirements for a link corresponding to a newly requested lightpath through the photonic switch, Extinction Ratio parameters of the photonic switch, number of lightpaths of different wavelength categories currently being serviced by the photonic switch, instances of crosstalk and/or potential crosstalk of various order currently in the switch. Other such parameters will be apparent to those skilled in the art.

Embodiments of the present invention relate to establishing a lightpath from a specified input to a specified output in a photonic switch. In some embodiments, such lightpath establishment can be performed after admission control. The photonic switch may already be accommodating one or more signals which cannot be re-routed. Lightpath establishment includes selecting a desired lightpath from among plural candidate lightpaths.

As will be readily understood by a worker skilled in the art, a photonic switch architecture such as but not limited to a Hybrid Dilated Benes architecture may be able to establish a lightpath from a specified switch input to a specified switch output along a number of different paths. Each of these paths corresponds to a candidate lightpath, and one may select a desired lightpath from among these lightpaths which is substantially optimal in a given sense. In the present invention, the desired lightpath maximizes a combination of cell sharing and cell packing, subject to certain crosstalk limitation conditions.

In some embodiments, maximizing the combination of cell sharing and cell packing comprises determining a desired lightpath that is Pareto efficient in terms of these two considerations. That is, the desired lightpath is such that no other feasible lightpath exists that is better in terms of both a measure of cell sharing and a measure of cell packing.

In some embodiments, maximizing the combination of cell sharing and cell packing comprises primarily maximizing cell sharing and secondarily maximizing cell packing. For example, a set of lightpaths which maximize cell sharing can be determined, and then, from among this determined set, the lightpath which also maximizes cell packing can be selected as the desired lightpath.

It is noted that other approaches to maximizing the combination of cell sharing and cell packing can be used. For example, some reduction in cell sharing may be allowed if a substantial improvement in cell packing can be obtained. In one embodiment, a value x indicative of a measure of cell sharing and a value y indicative of a measure of cell packing may be input into a scalar function f(x,y) which is increasing in both x and y, and the desired lightpath may be selected as the lightpath which maximizes the function f. In general, the maximization can correspond to a co-optimization of an objective having two variables.

In various embodiments, cell sharing corresponds to the number of switching cells in the photonic switch that concurrently accommodate plural lightpaths. As will be noted below, in certain embodiments and under certain conditions, crosstalk limitation conditions may be imposed that prohibit a switching cell from accommodating plural lightpaths of the same wavelength category. However, plural lightpaths belonging to different wavelength categories can be potentially accommodated by the same switching cell. The measure of cell sharing may thus be simply the count of the number of switching cells that accommodate plural lightpaths.

In various embodiments, the use of cell sharing results in reduced blocking probabilities for the switch. Since cells are shared where possible, a greater number of potential lightpaths are available in the switch, relative to the case where cells are not shared. As such, the probability of finding a desired lightpath in a given situation is increased.

In various embodiments, cell packing corresponds to the practice of arranging multiple lightpaths such that contiguous blocks of switching cells are utilized as much as possible. Although various definitions of cell packing may be used, in some embodiments cell packing corresponds to a measure of one or both of: a number of contiguously utilized switching cells within one or more columns of the photonic switch; and an average proximity of utilized switching cells within one or more columns of the photonic switch from respective reference cells of said one or more columns. The reference cells may be the cells along a schematically outer (e.g. top) edge of the photonic switch. In some embodiments, the one or more columns may include a center column of the photonic switch and/or a column comprising crosstalk-suppressed switching cells. Notably, the center column may comprise crosstalk-suppressed switching cells, as in the case of the Hybrid Dilated Benes architecture.

In one embodiment, any two different potential configurations of a photonic switch accommodating multiple lightpaths can be compared to determine which configuration exhibits a higher degree of cell packing. By comparing multiple potential configurations, an ordering may be established among the potential configurations. This ordering can reflect the relative amount of cell packing in each of configuration. This ordering may then be taken as the measure of cell packing.

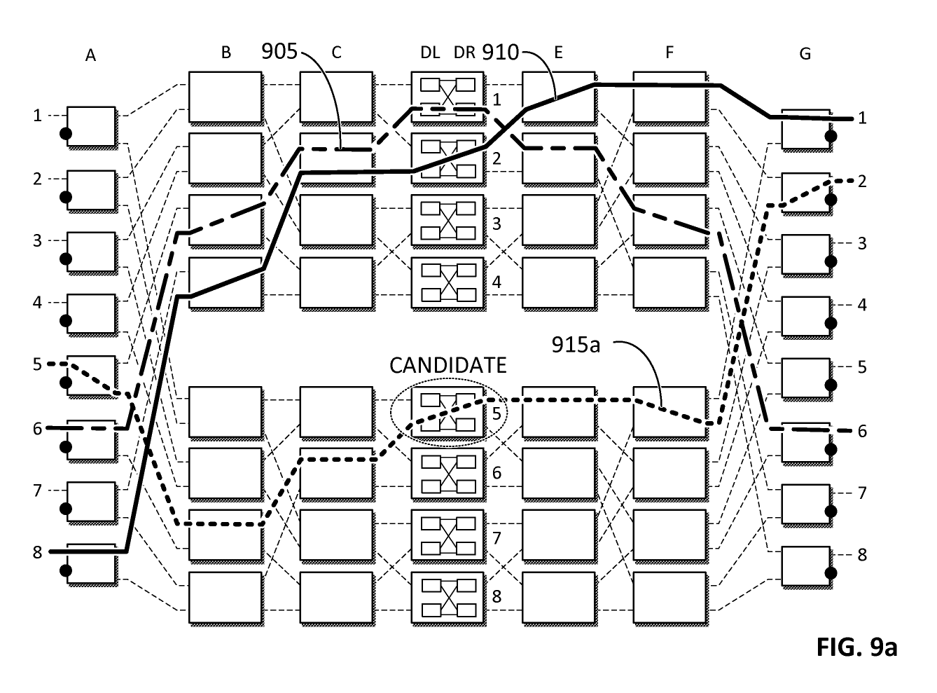

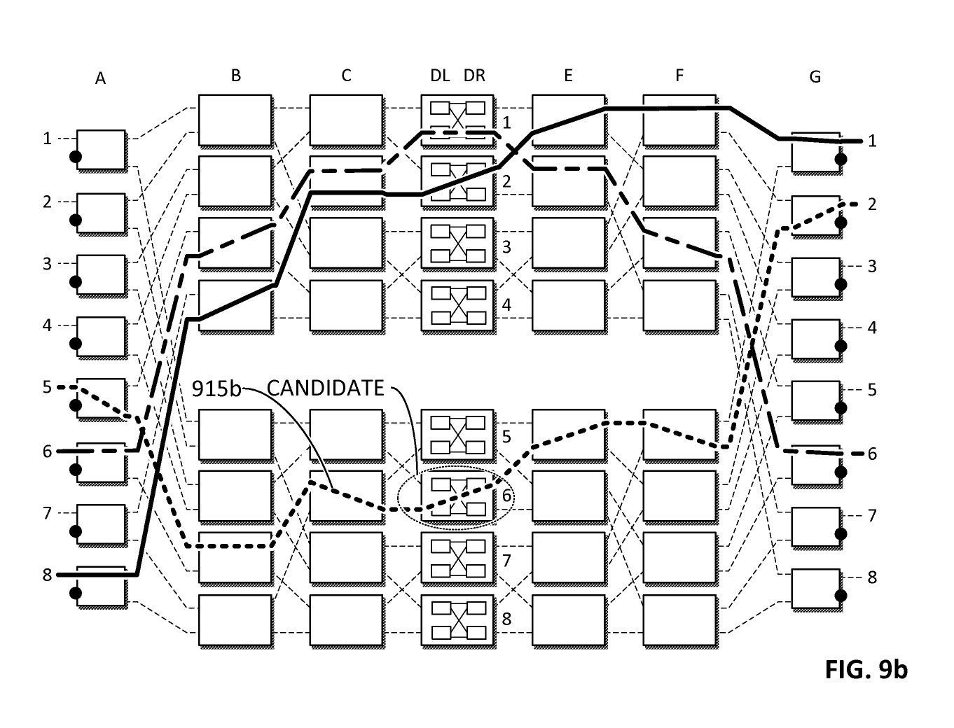

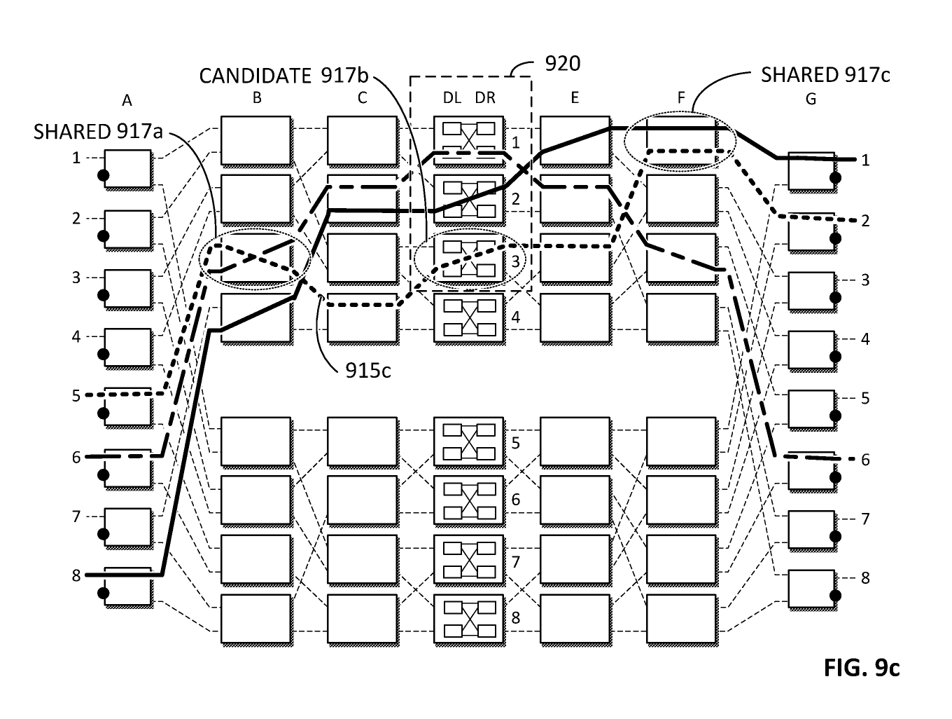

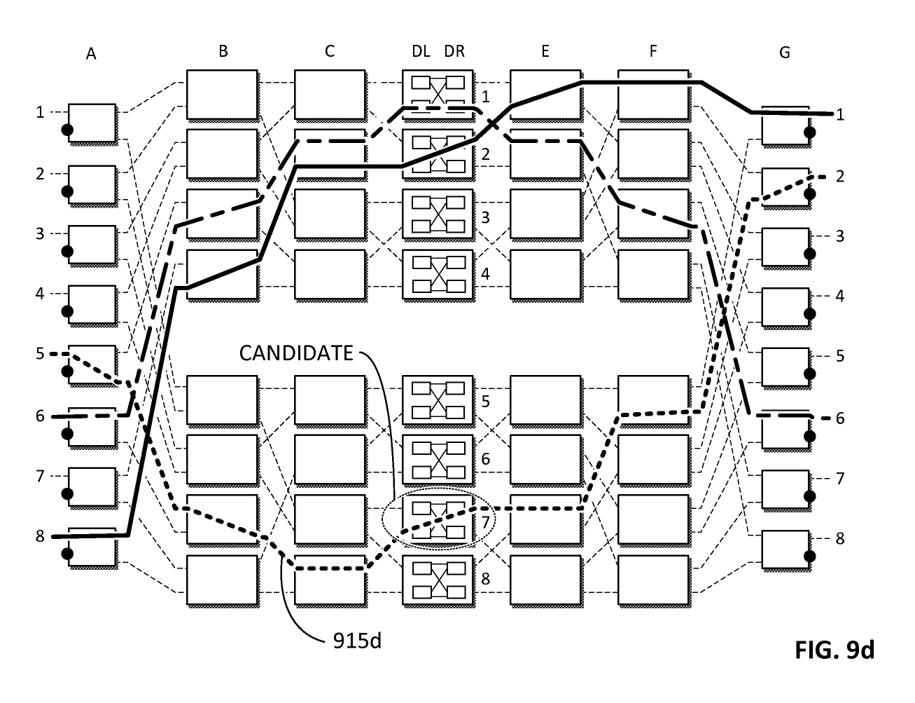

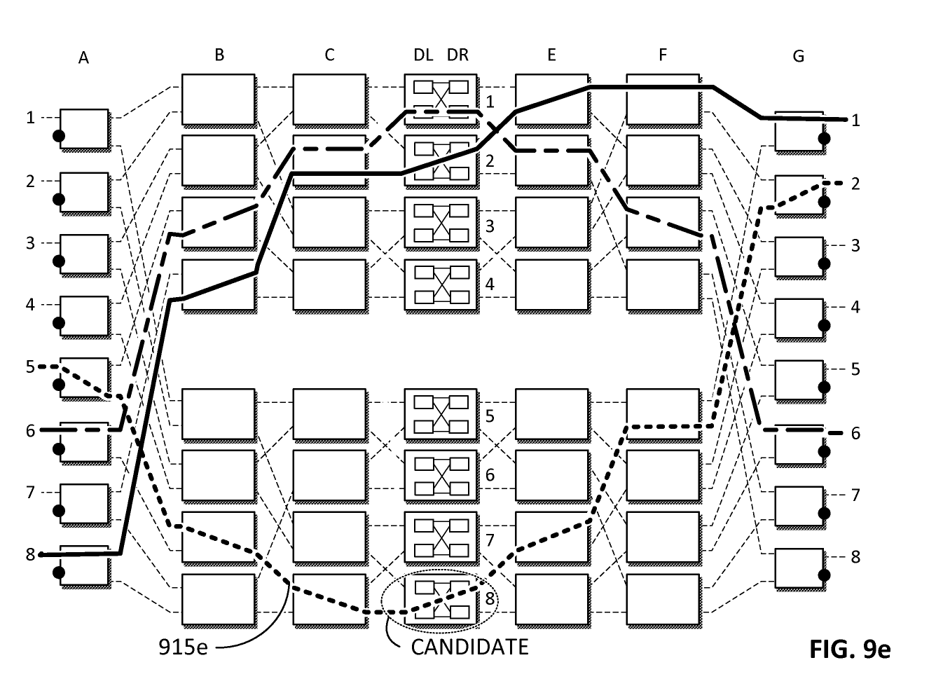

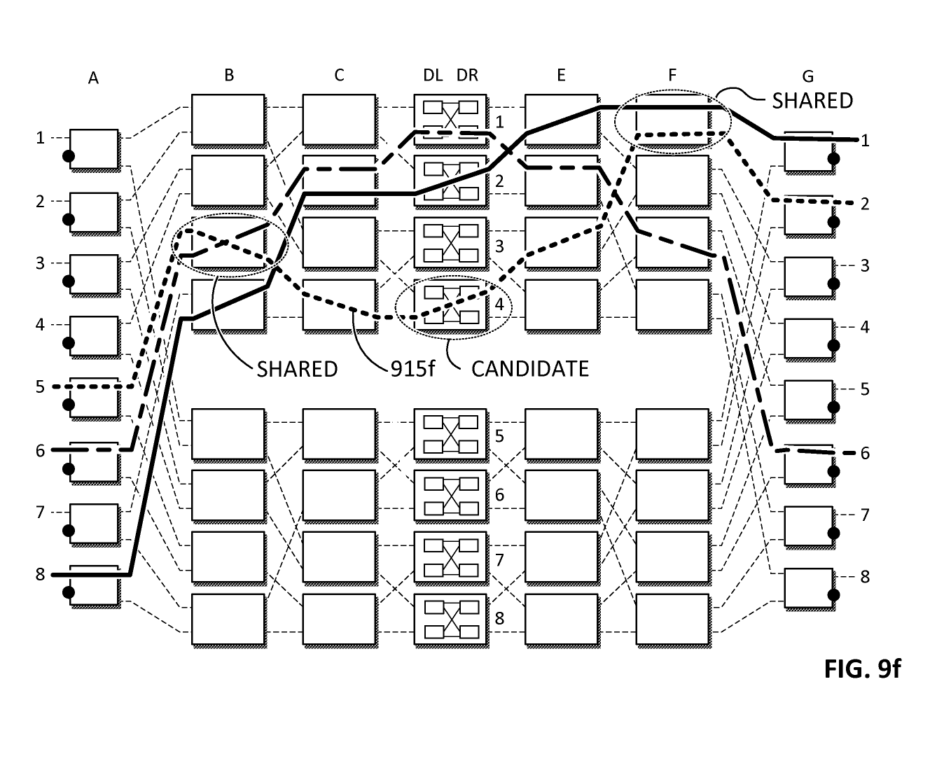

FIGS. 9a to 9f, 10a to 10g and 11a to 11b illustrate an example of lightpath selection and establishment in support of signal routing in accordance with an embodiment of the present invention. In FIGS. 9a to 9f, two existing lightpaths 905, 910 are established through an 8×8 Hybrid Dilated Benes photonic switch. The first lightpath 905 has a first wavelength (e.g. “red”) and is established from input 6 to output 6. The second lightpath 910 has a second wavelength (e.g. “blue”) and is established from input 8 to output 1. A request to establish a third lightpath is received, where the third lightpath is to be established from input 5 to output 2, and has a third wavelength (e.g. “green”). FIGS. 9a to 9f illustrate six different candidates 915a, 915b, 915c, 915d, 915e, 915f for the third lightpath. Two of the candidates 915c, 915f maximize cell sharing among candidates as each shares three switching cells with other existing lightpaths, e.g. cells 917a, 917b, 917c for path 915c. Note that cell sharing is allowed in this case since the wavelengths of all three lightpaths are different. Of the two candidates 915c, 915f, one candidate 915c utilizes a contiguous block 920 of three switching cells at the top of the center column of the switch, and therefore has higher cell packing. This candidate is selected as the desired lightpath and established.

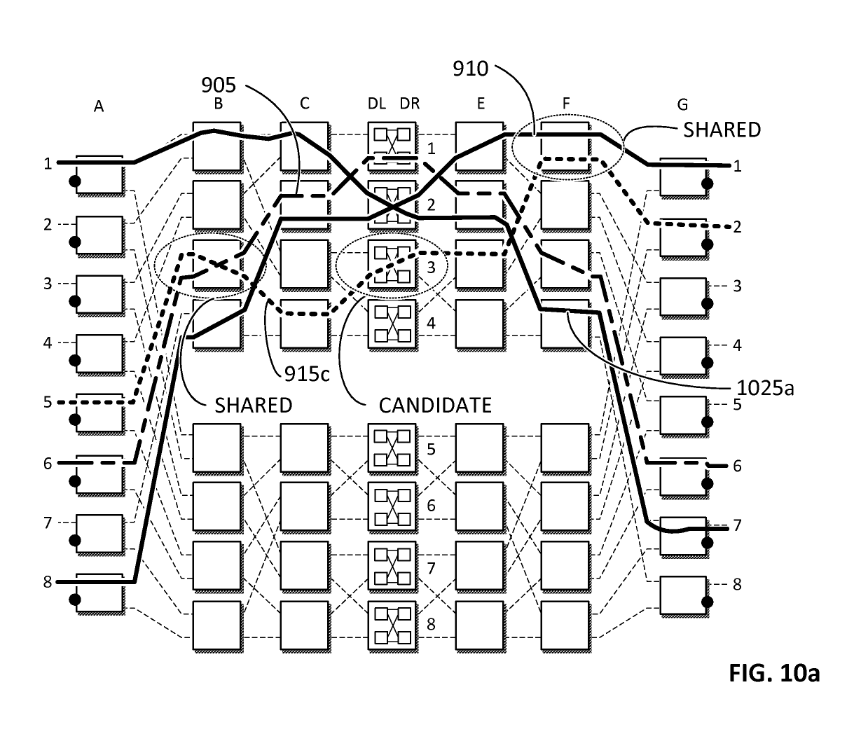

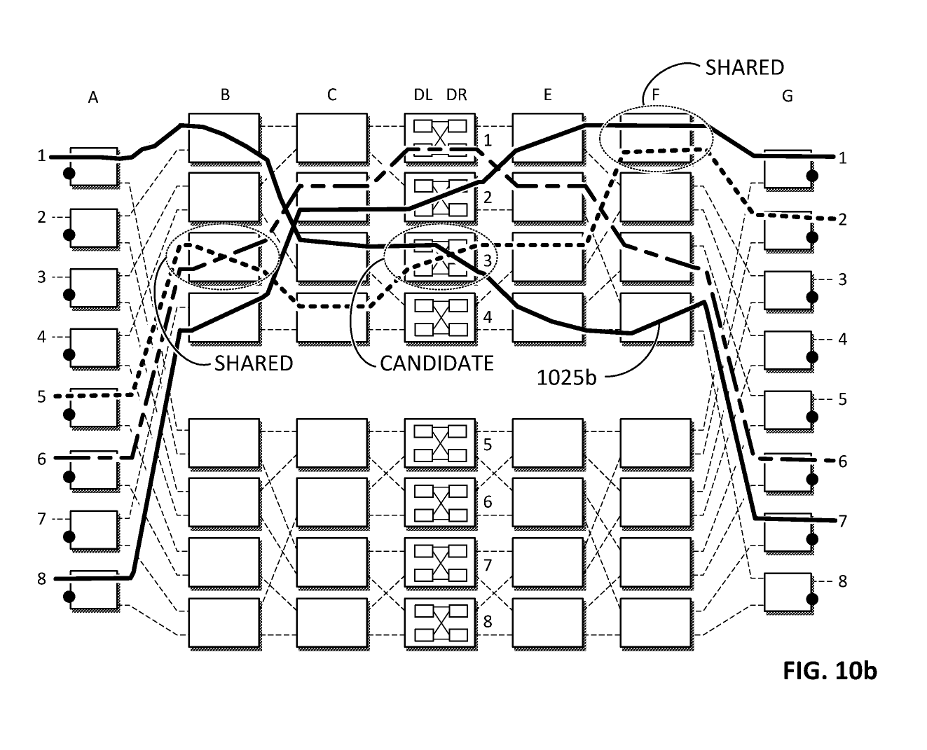

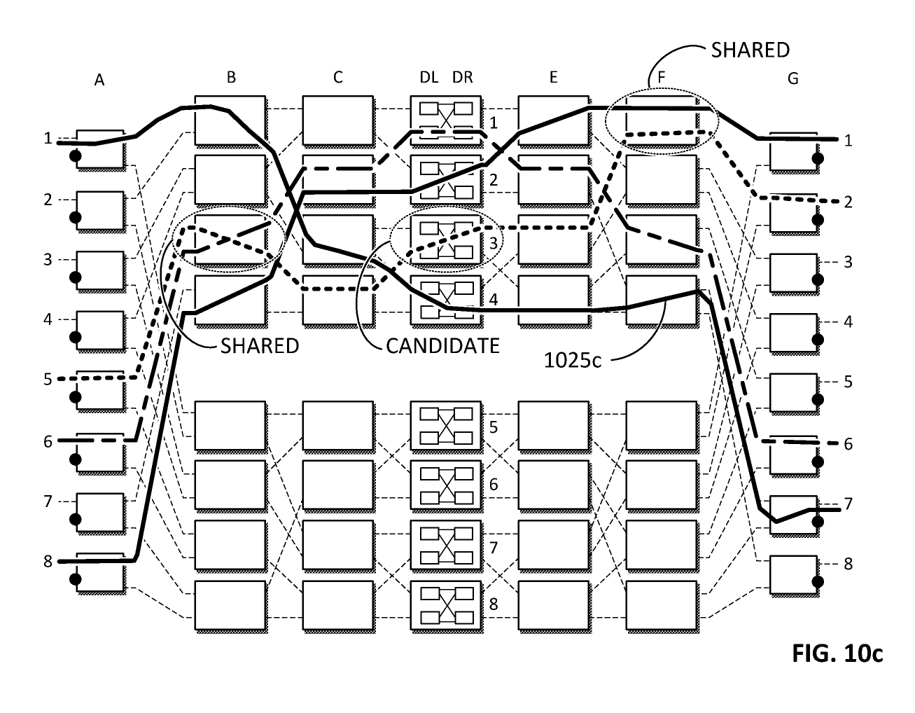

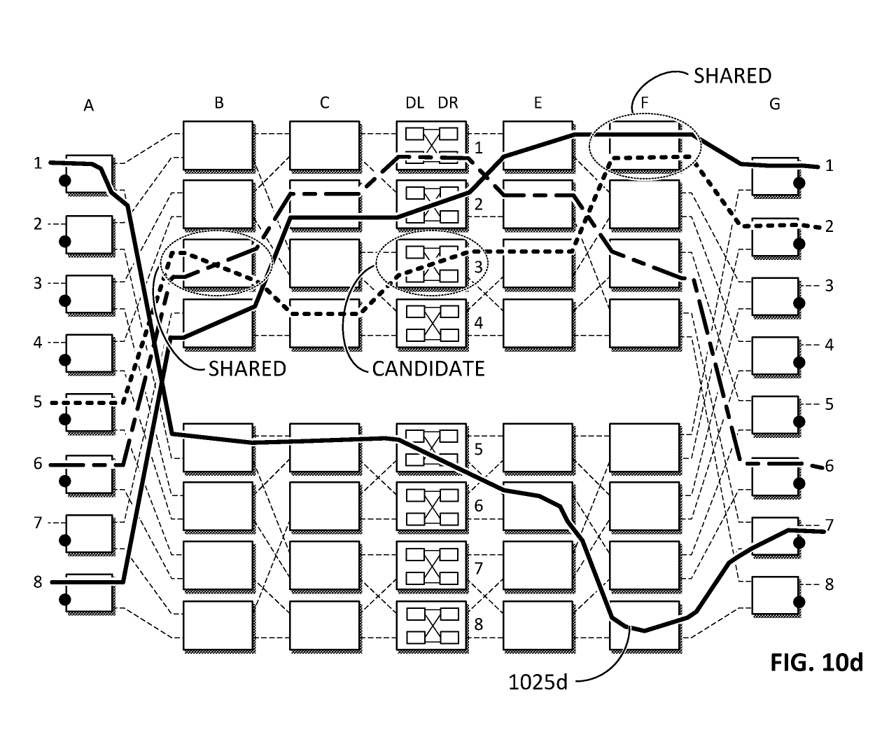

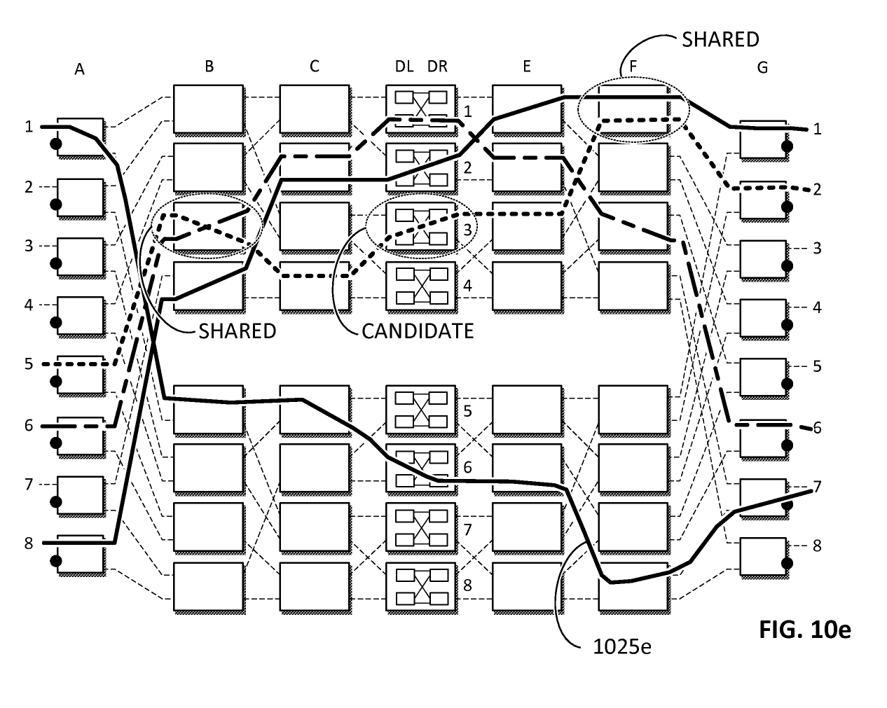

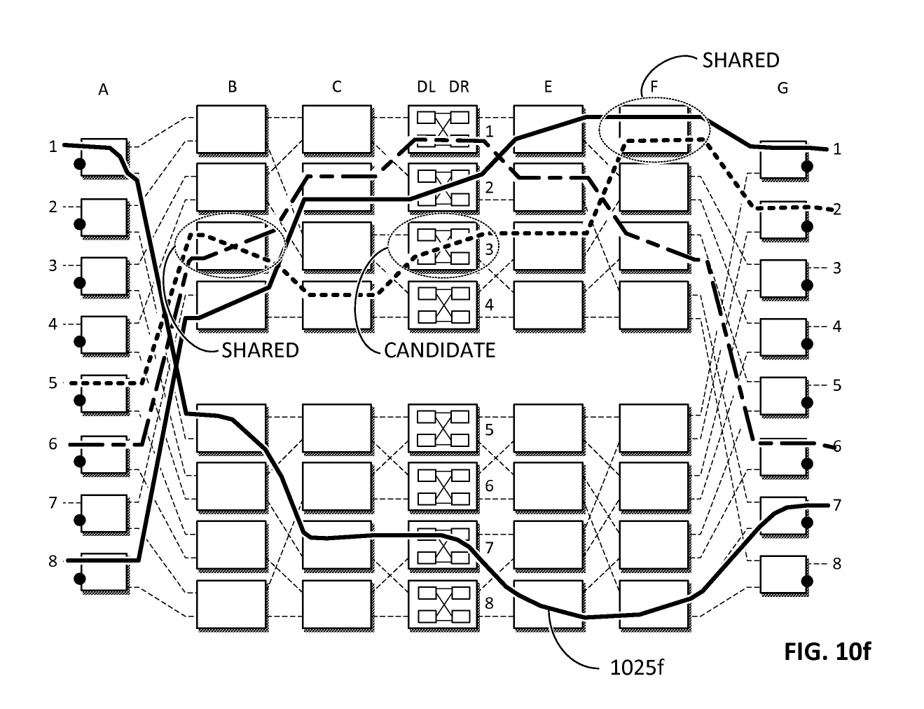

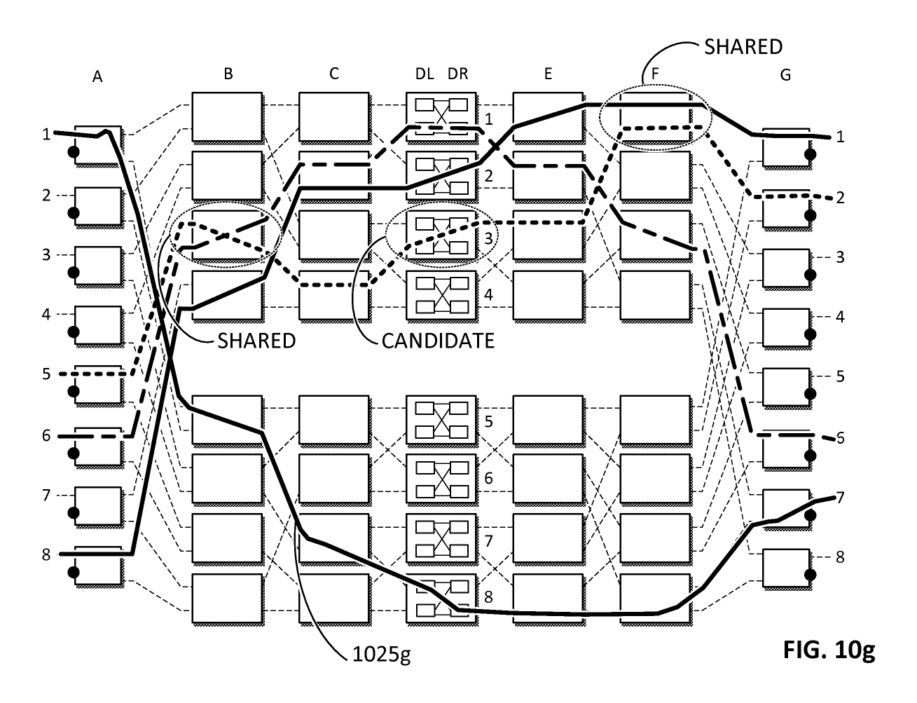

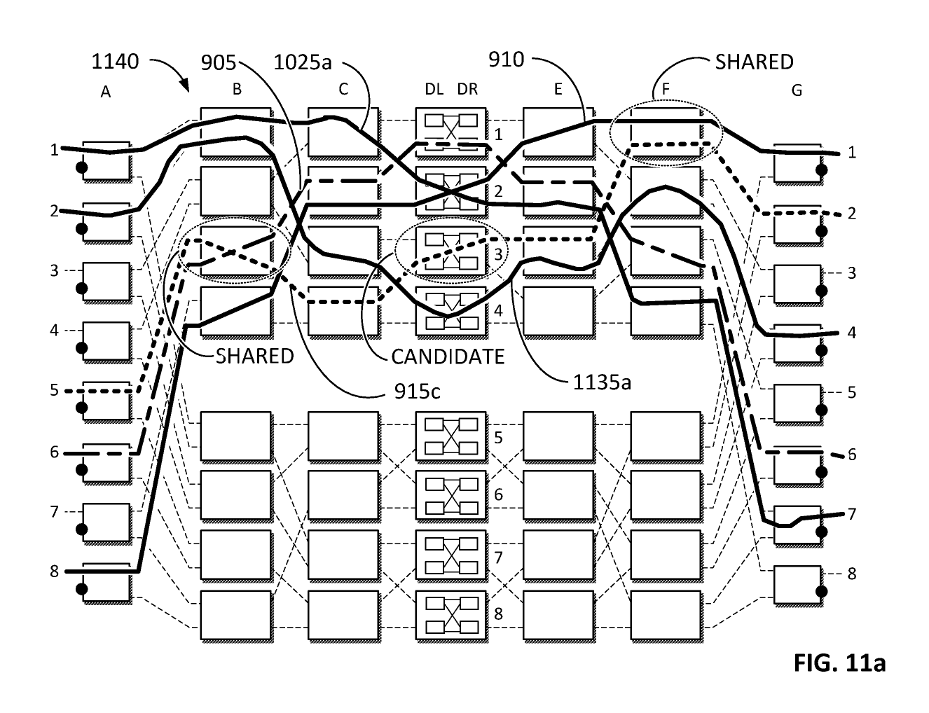

In FIGS. 10a to 10g, three existing lightpaths 905, 910, 915c are established through an 8×8 Hybrid Dilated Benes photonic switch in accordance with the description of FIGS. 9a to 9f. A request to establish a fourth lightpath is received, where the fourth lightpath is to be established from input 1 to output 7, and has the same wavelength as the second lightpath 910 (e.g. “blue”). FIGS. 10a to 10g illustrate seven different candidates 1025a, 1025b, 1025c, 1025d, 1025e, 1025f, 1025g for the fourth lightpath. Two of the candidates 1025a, 1025b maximize cell sharing among candidates as each shares one switching cell with another existing lightpath. Note that cell sharing is allowed in this case since it occurs in crosstalk-suppressed cells. Of the two candidates 1025a, 1025b, one candidate 1025a has higher cell packing because it uses a cell closer to the schematic top of the switch. This candidate is selected as the desired lightpath and established.

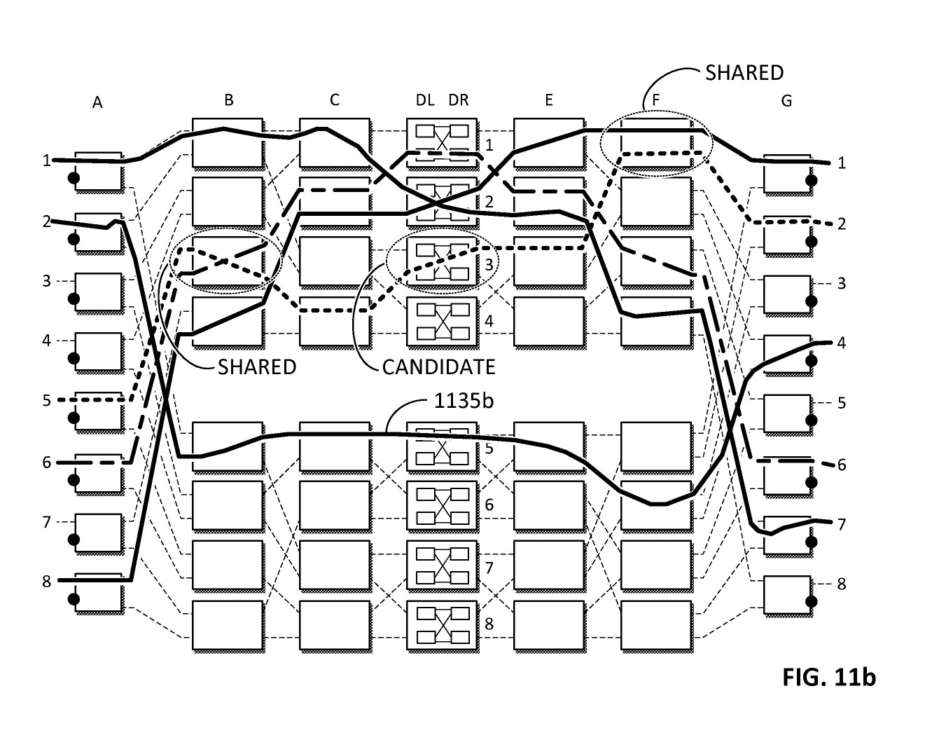

In FIGS. 11a to 11b, four existing lightpaths 905, 910, 915c, 1025a are established through the 8×8 Hybrid Dilated Benes photonic switch in accordance with the description of FIGS. 9a to 9f and 10a to 10g. A request to establish a fifth lightpath is received, where the fifth lightpath is to be established from input 2 to output 4, and has the same wavelength as the second lightpath 910 (e.g. “blue”). FIGS. 11a to 11b illustrate two different candidates 1135a, 1135b for the fourth lightpath, although more candidates may be possible. However, candidate 1135a would cause two lightpaths of same wavelength to share a single switching cell 1140 and is thus eliminated from consideration due to an imposed crosstalk limitation condition that prohibits a single non-crosstalk-suppressed switching cell from accommodating two lightpaths of the same wavelength. This is so even though candidate 1135a exhibits superior cell packing. In this case, candidate 1135b is selected as the desired lightpath and established.

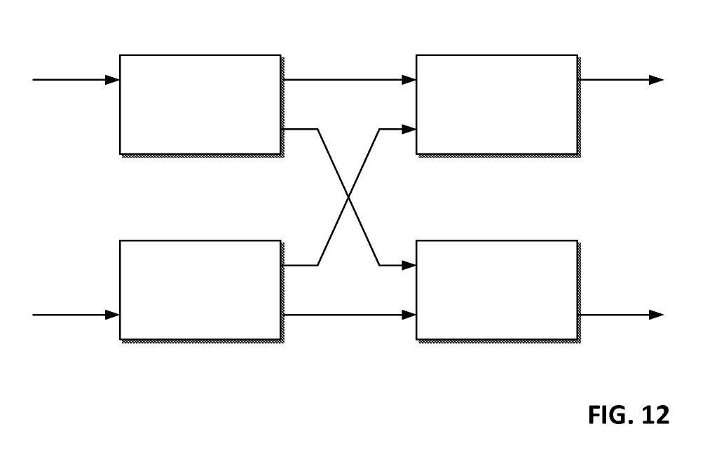

It is recognized herein that signal leakage may be tolerated between two signals in different optical wavelength categories, whereas first-order crosstalk between two signals in the same optical wavelength category may be problematic. As such, in certain embodiments of the present invention, situations which arise in first-order crosstalk between signals in the same optical wavelength category are explicitly avoided by the use of imposed crosstalk limitation conditions. In particular, a crosstalk limitation condition may be imposed that requires that at most one signal in a given optical wavelength category is to be concurrently routed through the same switching cell, unless that switching cell is a sufficiently crosstalk-suppressed switching cell. An example of a crosstalk-suppressed switching cell is a single cell formed from a cross-coupled arrangement of four regular switching cells, such as 2×1 and 1×2 cells, as illustrated in FIG. 12. The four switching cells may be controlled in a coordinated manner so as to function similarly to a single regular switching cell. Such crosstalk-suppressed cells may be used for example in the center column of a Hybrid Dilated Benes switch architecture, or in a Dilated Banyan switch architecture, for example.

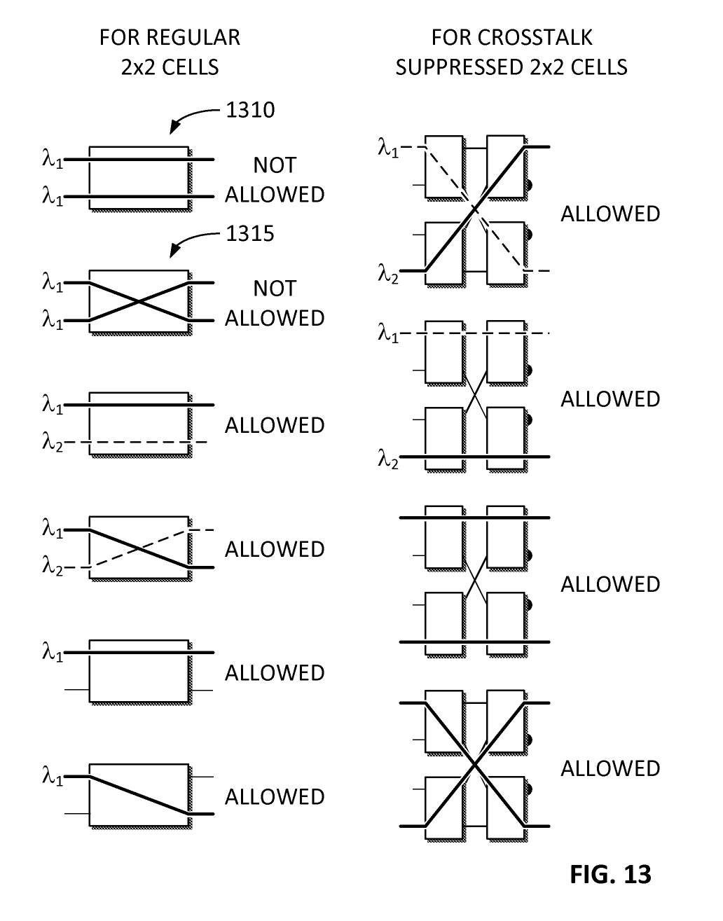

FIG. 13 illustrates several potential switching cell configurations. Solid lines indicate a lightpath of a first wavelength, while dashed lines indicate a lightpath of a second, different wavelength. The above-described crosstalk limitation condition imposes that configurations 1310 and 1315 are not to be used since they require a non-crosstalk-suppressed switching cell to accommodate two lightpaths of the same wavelength. Configuration 1310 is a bar configuration in which two lightpaths of the same wavelength pass through the switching cell. Configuration 1315 is a cross configuration in which two lightpaths of the same wavelength pass through the switching cell. The other illustrated configurations are allowed.

In some embodiments, the sole crosstalk limitation condition is the above requirement that, for regular, non-crosstalk-suppressed switching cells, at most one signal in a given optical wavelength category is to be concurrently routed through the same switching cell. This condition is relatively efficient to implement, since it only requires consideration and tracking of first-order crosstalk. With this condition, the order of crosstalk at each output is second order. In other embodiments, more or different crosstalk limitation conditions are imposed.

In some embodiments, crosstalk limitation conditions may be imposed that restrict lightpath configurations which would lead to predetermined amounts of occurrence of crosstalk of various order. For example, a crosstalk limitation condition may dictate that a lightpath may have at most kₙ instances of crosstalk of order n, where kₙ is specified for n=1, 2, 3 . . . . In various embodiments, kₗ=0. As another example, a crosstalk limitation condition may dictate that a lightpath must maintain a crosstalk score S of less than a predetermined maximum value. A possible equation for computing crosstalk score is a sum S=Σₙ(aₙkₙ) where the aₙ are decreasing values, for example exponentially decreasing values. Crosstalk limitation conditions may be evaluated for existing lightpaths as well as requested new lightpaths. Determining the number of occurrences of crosstalk of various orders may be performed computationally by considering proposed lightpath combinations within a switch. Various rules and mathematical relationships may be derived for counting crosstalk occurrences for a given switching architecture may be developed and implemented.

In some embodiments, crosstalk limitation conditions may be adjusted based on operating conditions, such as photonic switch Extinction Ratio (ER) or more generally optical crosstalk parameters descriptive of the photonic switch. For example, when the ER is within a first range, such as between 18 and 23 dB, the crosstalk limitation of at most one signal per wavelength category per cell may be imposed. When the ER is at or above a threshold such as 28 dB or 30 dB, all crosstalk limitation conditions may be removed. Each crosstalk limitation condition or combination of conditions may be imposed under predetermined operating conditions and suspended under other operating conditions. In some embodiments, suspending crosstalk limitation conditions when they are not needed increases the number of potential paths through the switch, for example by increasing the potential for cell sharing, and therefore reduces blocking probabilities of the switch. By limiting the imposition of crosstalk limitation conditions, a balance between OSNR aware routing and switch utilization, in terms of number of links serviced by a switch, can be achieved.

It is noted that, as illustrated in FIG. 13, various embodiments of the invention comprise permitting multiple lightpaths of different wavelengths to be established through a single common switching cell. This cell sharing may allow for a greater number of potential lightpaths and hence a greater capacity of the photonic switch.

Embodiments of the present invention provide for signal routing and associated selection and establishment of lightpaths which is adapted based on optical crosstalk parameters of the photonic switch, such as an Extinction Ratio (ER) of the switch. If the ER is higher than a predetermined threshold, such as 28 dB or 30 dB, then lightpath selection and routing proceeds without considering admission control or crosstalk limitation conditions, also referred to as cell sharing constraints. Otherwise, lightpath selection and routing proceeds in an OSNR-aware manner. As such, a single approach may be used which is OSNR-aware when required. Embodiments of the present invention provide for adaptive signal routing over lightpaths, wherein a rule set for admission control and/or signal routing is adjusted based on one or more factors such as OSNR requirements and ER.

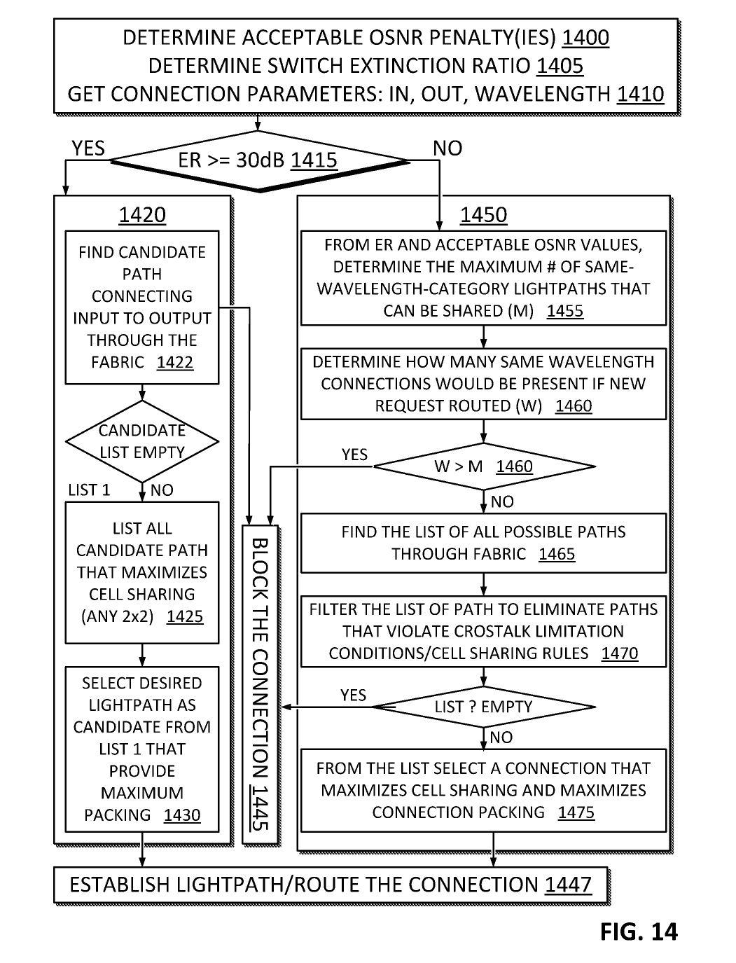

FIG. 14 illustrates a flow chart showing an example of adaptive signal routing over lighpaths in accordance with an embodiment of the present invention. Following receipt of a request to route a signal and/or establish a lightpath, an acceptable OSNR penalty, or set of penalties, for lightpaths serviced by the switch is determined 1400. For example, determining the acceptable OSNR penalties may include receiving these values from the optical network operator. An ER for the switch is also determined 1405, and parameters for the request such as specified input, specified output, and wavelength category of the lightpath are determined 1410. Determining the ER may include obtaining an ER value specified for the switch, for example as determined after manufacture of the switch and stored in a table or data field held in local or remote memory. The ER is evaluated 1415 and, if the ER is greater than the predetermined threshold (30 dB in the present example), then a first routing routine 1420 is followed. If the ER is less than the predetermined threshold, then a second routing routine 1450 is followed.

In the first routing routine 1420, candidate lightpaths through the switching fabric from the specified input to the specified output are determined 1422 which can accommodate the request, in the presence of already-established lightpaths which may block certain routes through the switching fabric from the specified input to the specified output. Neither wavelength of the request nor OSNR penalties are considered. If the candidate list is empty, for example due to all potential paths being blocked by already-established lightpaths, then the requested connection is blocked 1445. Otherwise, a first list of candidate lightpaths which maximize cell sharing is determined 1425, and from among these candidate lightpaths, a desired lightpath is selected 1430 which also maximizes cell packing. If there are multiple such lightpaths, one is selected randomly. The desired lightpath is then established 1447, and the corresponding connection routed, by operation of the photonic switch.

In the second routing routine 1450, a maximum number M of lightpaths of same wavelength category which can be concurrently accommodated by the switch is determined 1455, based on the ER and OSNR penalty or set of penalties. A determination 1460 is made as to whether accommodating the received request would result in the number of lightpaths of same wavelength category, concurrently accommodated by the switch, being greater than M. If so, the connection is blocked 1445. Otherwise, an attempt to find a feasible lightpath for accommodating the request is made.

In particular, a list of candidate lightpaths through the switching fabric from the specified input to the specified output are determined 1465 which can accommodate the request, in the presence of already-established lightpaths which may block certain routes through the switching fabric from the specified input to the specified output. Candidate lightpaths that would not respect predetermined crosstalk limitation conditions such as cell sharing rules are filtered out 1470 of the list. If the candidate list is empty, for example due to all potential paths being blocked by already-established lightpaths or due to a lack of potential paths that respect crosstalk limitation conditions, then the requested connection is blocked 1445. Otherwise, candidate lightpaths which maximize a combination of cell sharing and optionally cell packing are determined 1475. If there are multiple such lightpaths, one is selected randomly. The desired lightpath is then established 1447, and the corresponding connection routed, by operation of the photonic switch.

Alternatively, the second routing routine 1450 may comprise another form of OSNR-aware admission control followed by OSNR-aware routing with cell sharing maximization and crosstalk limitation constraints as described herein.

Embodiments of the present invention relate to a photonic switch configured to operate in accordance with the above description. The photonic switch may include a switching fabric as well as an apparatus for handling a request to establish a lightpath in the photonic switch and/or for routing a signal over the lightpath in the photonic switch. The photonic switch can be of a variety of architectures in which switching cells are interconnected and prone to crosstalk. Such architectures include but are not necessarily limited to N×N Dilated Benes architectures, N×N Hybrid Dilated Benes architectures, and multi-stage CLOS architecture.

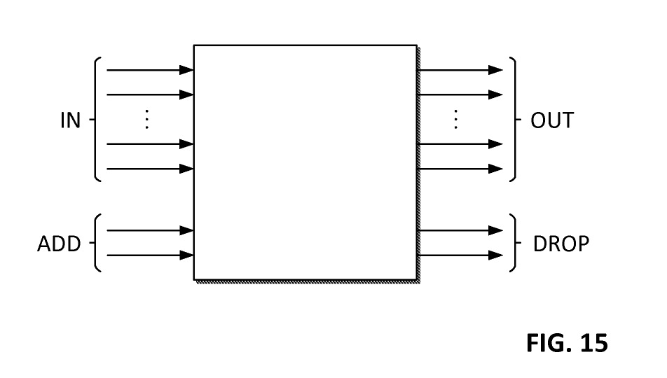

Embodiments of the present invention provide for an optical network node comprising multiple instances of the above-described photonic switch, for example with several photonic switches being operated in parallel, arranged in a two-dimensional grid configuration, or the like. Such photonic switches may be operated in the manner described herein. FIG. 15 schematically illustrates an example of such an optical network node having multiple ports. The number of ports may be affected by the number of nodes/directions the optical network node communicates optical transit signals with, by the bandwidth (e.g., number of wavelengths) on each interconnection, and by the number of add/drop signals. It is likely that next-generation optical network nodes will need to switch in the neighborhood of four hundred incoming wavelengths over four hundred outgoing wavelengths (400×400) to satisfy the bandwidth, directional, and add/drop demands of tomorrow's metro and core optical networks.

In some embodiments, the optical network node of FIG. 15 may be a four-degree Dense Wavelength Division Multiplexing (DWDM) node with 25% add and drop capability. As such, there may be 320 pass-through inputs, 320 pass-through outputs, 80 “ADD” inputs and 80 “DROP” outputs. Alternatively, the node may be a 480×480 or 512×512 node. In some embodiments, an optical network node such as the node illustrated in FIG. 15 includes a plurality of multi-stage photonic switches, for example as set forth in U.S. Patent Application Publication No. 2015/0055951.

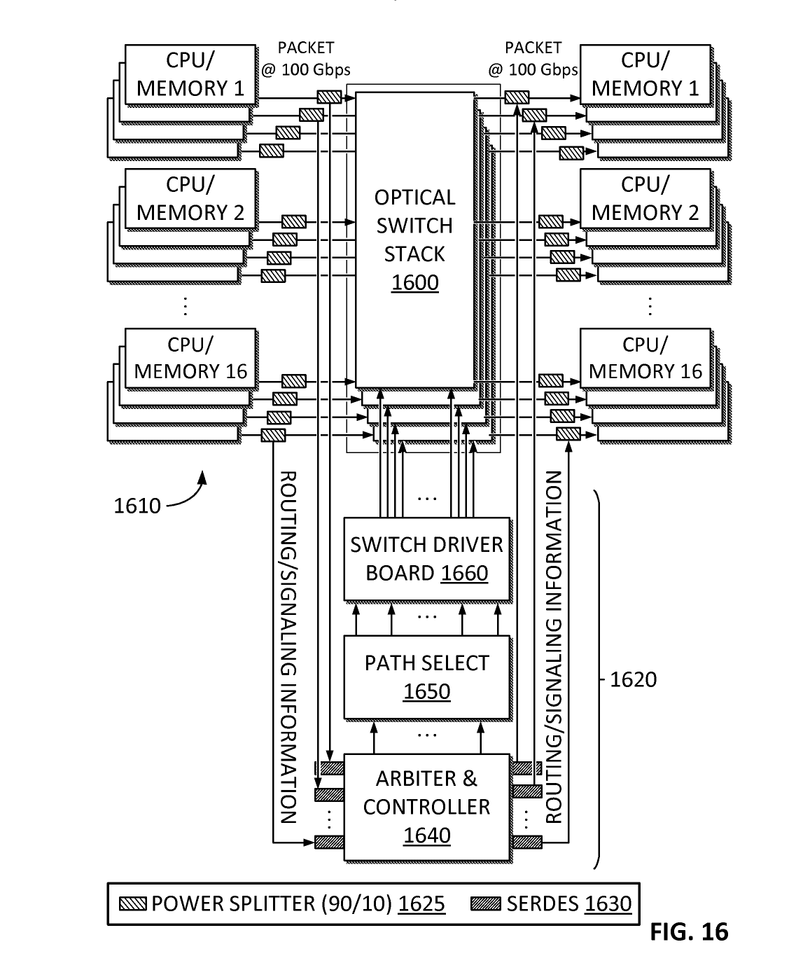

Embodiments of the present invention provide for a high-performance computing architecture comprising a photonic switch stack comprising multiple instances of the above-described photonic switch, configured to operate in accordance with the above description, for example with several photonic switches being operated in parallel. FIG. 16 illustrates an example of such a computing architecture. A photonic switch stack 1600 is provided for interconnecting plural banks 1610 of CPU processors and/or memory modules on an as-needed basis, in order to exchange information between such banks. The photonic switch stack 1600 may include photonic switches operating in parallel and commonly controlled by a switch controller 1620. The switch controller drives the photonic switches and implements OSNR-aware admission control and/or OSNR-aware signal routing.

In the illustrated embodiment, power splitters/combiners 1625, such as 90/10 power splitters, are coupled to optical signal pathways which couple each bank 1610 of CPU processors/memory modules to the photonic switch stack 1600. The power splitters allow for activity on the optical signal pathways to be monitored and provided to the switch controller 1620 as routing/signalling information. A bank of serial/deserializers 1630 may be provided for coupling the routing/signalling information to an arbiter and controller module 1640 of the controller. In some embodiments, the serial/deserializers 1630 may also transmit information for coupling onto the optical signal pathways.

The arbiter and controller module 1640 may perform lightpath admission control, for example. Admission control may be performed on a per-photonic switch basis, and further the arbiter and controller module 1640 may be configured to determine one switch of the stack which can admit requested optical signals under the OSNR-aware admission control rules of the present invention.

The switch controller 1620 further includes a path selector 1650 which is configured to derive OSNR-aware routing solutions for use by photonic switches in the photonic switch stack 1600, potentially along with performing other path selection operations as required.

The switch controller 1620 further includes a switch driver board 1660 which is configured to provide control signals to photonic switches in the photonic switch stack 1600 for configuring the switching cells therein, as directed by the controller to establish lightpaths through the photonic switches as required.

High performance computing architectures, and photonic computing architectures, make use of a plurality of processors and associated memories. The use of photonic signalling paths allows for a higher bandwidth connection than can be provided by electrical connections. In order to exchange data between processing centers or cores, signals must be routed without exceeding a degradation threshold. Applications of the above method and controllers can allow for a high performance computing system that makes use of non-blocking routing of signals without exceeding degradation thresholds.

In various embodiments, a limited number of wavelength categories, for example four different wavelength categories, are used in the computing architecture of FIG. 16. This may arise due to cost constraints, for example. To mitigate potential problems in such scenarios, OSNR-aware lightpath admission control and routing solutions as described above are implemented.

For example, the four different wavelength categories potentially used in the computing architecture of FIG. 16 may relate to 4×25 G for 100 GE in current datacenters, or alternatively to 4×50 G or 4×100 G for future datacenters, where 4 is the number of wavelengths and 25 G, 50 G or 100 G is the rate of each wavelength. In typical scenarios, all CPU and memory modules in a datacenter application use the same number of wavelengths and rate due to cost constraints.

In some embodiments of the computing architecture of FIG. 16, multiple wavelengths (e.g. all 4 wavelengths) are collectively used to pass data from one bank 1610 to another, for example via one lightpath. The use of multiple wavelengths may allow for a higher data rate at a controlled cost.

Various embodiments of the present invention relate to a method of handling a request to establish a lightpath in a photonic switch and/or of establishing the lightpath. The method may be implemented for example by a computer configured to receive input, perform computations, and provide output in furtherance of such methods. The computer may be operatively coupled to memory in which program instructions are stored for execution by the computer. Inputs may include requests to establish lightpaths, information indicative of OSNR requirements, and other such information and requests that will be apparent to those skilled in the art. The computer may track parameters such as characteristics of current lightpaths established through the switch, optical crosstalk parameters of the switch, and the like. The computer may provide outputs such as control signals for operating the switching cells of the photonic switch or signals indicative that a request is being blocked.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of handling a request to establish a lightpath in a photonic switch from a specified input to a specified output, the method comprising:
determining an Optical Signal-to-Noise Ratio (OSNR) requirement; and
when the request can be accommodated while satisfying the OSNR requirement, establishing the lightpath from the specified input to the specified output along a route which satisfies the OSNR requirement.

2. The method of claim 1, wherein the step of determining the OSNR requirement includes determining more than one OSNR requirement.

3. The method of claim 1, wherein the OSNR requirement is prescribed for one or more of: optical signal links currently passing through the photonic switch;
portions of optical signal links currently passing through the photonic switch;
an optical signal link to be established through the photonic switch in association with the request; and
a portion of the optical signal link to be established through the photonic switch in association with the request.

4. The method of claim 1, wherein the lightpath corresponds to light of a specified wavelength category, the method further comprising:
determining a maximum number of lightpaths, of the specified wavelength category, that can be concurrently established in the photonic switch, in accordance with an optical crosstalk parameter of the switch and the OSNR requirement; and
blocking the request when a violation condition indicating that establishing the lightpath would result in a number of concurrently established lightpaths for the specified wavelength category in excess of the maximum number is met.

5. The method of claim 4, wherein the number of concurrently established lightpaths in the violation condition is equal to a count of optical signal links carrying light of the specified wavelength category which would concurrently pass through the photonic switch.

6. The method of claim 1, wherein establishing the lightpath from the specified input to the specified output comprises:
determining a plurality of candidate lightpaths in the photonic switch from the specified input to the specified output;
selecting, from among the plurality of candidate lightpaths, a desired lightpath which maximizes a number of shared cells subject to predetermined crosstalk limitation conditions, wherein shared cells are those that concurrently accommodate plural lightpaths; and
establishing the lightpath in the photonic switch as the desired lightpath.

7. The method of claim 6, further comprising selecting the desired lightpath to maximize a combination of shared cells and cell packing.

8. The method of claim 7, wherein selecting the desired lightpath only considers cell packing as it relates to packing of cells in a central column of the photonic switch.

9. The method of claim 7, wherein selecting the desired lightpath only considers cell packing as it relates to packing of crosstalk suppressed cells in the photonic switch.

10. The method of claim 1, wherein the OSNR requirement corresponds to a limit on OSNR penalty to be introduced by the photonic switch into a corresponding optical signal link serviced by the photonic switch.

11. The method of claim 10, wherein the limit on OSNR penalty is determined according to a link budget specified for the corresponding optical signal link.

12. The method of claim 1, wherein the method is performed if an Extinction Ratio of the photonic switch is below a threshold, and otherwise an alternative method of handling a request to establish a lightpath in a photonic switch is performed.

13-24. (canceled)

25. An apparatus for handling a request to route a requested signal through a photonic switch from a specified input to a specified output, the apparatus comprising a controller having:
an OSNR module configured to determine an Optical Signal-to-Noise Ratio (OSNR) requirement; and
a routing module operatively coupled to the photonic switch and configured to provide control signals causing the photonic switch to establish a lightpath for routing the requested signal from the specified input to the specified output, the lightpath satisfying the OSNR requirement.

26. The apparatus of claim 25 wherein determining the OSNR requirement includes determining more than one OSNR requirement.

27. The apparatus of claim 25, wherein the routing module is configured to provide said control signals when the requested signal is routable through the photonic switch while satisfying the OSNR requirement.

28. The apparatus of claim 25, wherein the OSNR requirement is prescribed for one or more of: optical signal links currently passing through the photonic switch; portions of optical signal links currently passing through the photonic switch; an optical signal link to be established through the photonic switch in association with the request; and a portion of the optical signal link to be established through the photonic switch in association with the request.

29. The apparatus of claim 25, wherein the lightpath corresponds to light of a specified wavelength category, the controller further configured to:
determine a maximum number of lightpaths, of the specified wavelength category, that can be concurrently established in the photonic switch, in accordance with an optical crosstalk parameter of the switch and the OSNR requirement; and
block the request when a violation condition indicating that establishing the lightpath would result in a number of concurrently established lightpaths for the specified wavelength category in excess of the maximum number is met.

30. The apparatus of claim 29, wherein the number of concurrently established lightpaths in the violation condition is equal to a count of optical signal links carrying light of the specified wavelength category which would concurrently pass through the photonic switch.

31. The apparatus of claim 25, wherein the controller is further configured to:
determine a plurality of candidate lightpaths in the photonic switch from the specified input to the specified output;
select, from among the plurality of candidate lightpaths, a desired lightpath which maximizes a number of shared cells subject to predetermined crosstalk limitation conditions, wherein shared cells are those that concurrently accommodate plural lightpaths; and
establish the lightpath in the photonic switch as the desired lightpath.

32. The apparatus of claim 31, wherein the controller is further configured to select the desired lightpath to maximize a combination of shared cells and cell packing.

33. The apparatus of claim 32, wherein the controller is further configured to select the desired lightpath only based on cell packing as it relates to packing of cells in a central column of the photonic switch.

34. The apparatus of claim 32, wherein the controller is further configured to select the desired lightpath only based on cell packing as it relates to packing of crosstalk suppressed cells in the photonic switch.

35-40. (canceled)
